(19) United States
(12) Patent Application Publication
(10) Pub. No.: US 2024/0314592 A1
(43) Pub. Date: Sep. 19, 2024

(54) TASK PROCESSING METHOD AND APPARATUS

(71) Applicant: HUAWEI TECHNOLOGIES CO., LTD., Shenzhen (CN)

(72) Inventors: Jun WANG, Shanghai (CN); Chenghui PENG, Shanghai (CN); Shaoyun WU, Shanghai (CN); Jianjun WU, Shenzhen (CN)

(21) Appl. No.: 18/677,299

(22) Filed: May 29, 2024

Related U.S. Application Data
(63) Continuation of application No. PCT/CN2022/135052, filed on Nov. 29, 2022.

(30) Foreign Application Priority Data
Nov. 30, 2021 (CN) 202111447706.9

(51) Int. Cl. H04W 24/02; H04W 8/22; H04W 76/12; H04W 76/20

(52) U.S. Cl. CPC H04W 24/02; H04W 8/22; H04W 76/12; H04W 76/20

(57) ABSTRACT

This application discloses a task processing method and an apparatus. The method includes the following steps: A first node determines a first task, and sends a first message. The first node includes a first core network device and/or a first access network device, the first task is a task related to artificial intelligence AI, the first message includes identification information of a second task and/or configuration information of the second task, the second task is a subtask of the first task, the second task is executed by a second node, and the second node is one of nodes configured to execute the first task.

### CROSS-REFERENCE TO RELATED APPLICATIONS

This application is a continuation of International Application No. PCT/CN2022/135052, filed on Nov. 29, 2022, which claims priority to Chinese Patent Application No. 202111447706.9, filed on Nov. 30, 2021. The disclosures of the aforementioned applications are hereby incorporated by reference in their entireties.

### TECHNICAL FIELD

This application relates to the field of communication technologies, and in particular, to a task processing method and an apparatus.

### BACKGROUND

With development of communication systems, artificial intelligence (AI) will be increasingly applied in future communication systems.

Currently, to enable a related device to execute a specific task, the related device usually executes the task by receiving program code.

### SUMMARY

This application provides a task processing method and an apparatus, to effectively improve AI task management efficiency.

According to a first aspect, an embodiment of this application provides a task processing method. The method includes the following steps.

A first node determines a first task, where the first node includes a first core network device and/or a first access network device, and the first task is a task related to artificial intelligence (AI). The first node sends a first message, where the first message includes identification information of a second task and/or configuration information of the second task, the second task is a subtask of the first task, the second task is executed by a second node, and the second node is one of determined nodes configured to execute the first task.

In this embodiment of this application, the first core network device and/or the first access network device manages and controls an AI task. In this way, related management/control of the AI task is standardized, thereby effectively improving AI task management efficiency.

According to the method provided in this embodiment of this application, a related processing procedure of the AI task is standardized. Compared with a method for managing and controlling a task by using program code, a case in which program code needs to be updated in real time is effectively avoided, thereby effectively improving AI task management efficiency.

In at least one implementation, the first message further includes identification information of the first task.

In this embodiment of this application, the identification information of the first task is included, so that the second node can learn that the second task is obtained by decomposing the first task.

In at least one implementation, a type of the first task includes any one or more of the following: an inference task, a training task, a learning task, a computing task, or a sensing task.

In at least one implementation, that a first node determines a first task includes the following step: the first node determines any one or more of life cycle information of the first task, resource information of the first task, allocation information of the first task, and decomposition information of the first task.

In at least one implementation, the life cycle information of the first task includes any one or more of the following: addition of the first task, modification of the first task, querying of the first task, reporting of the first task, migration of an execution node of the first task, and migration of a management node of the first task; the resource information of the first task includes any one or more of the following: computing power of the first task, an algorithm of the first task, data of the first task, or a connection of the first task: the allocation information of the first task includes any one or more of the following: allocation of an execution node of the first task, allocation of an execution type of the execution node of the first task, and resource allocation of the execution node of the first task; and/or the decomposition information of the first task includes any one or more of the following: a quantity of tasks obtained by decomposing the first task and computing power decomposition of the first task.

In this embodiment of this application, the first core network device and/or the first access network device can more flexibly allocate a task by decomposing and/or allocating the first task, so that the second node can execute a task that matches a capability of the second node, thereby further improving AI task management efficiency, and further improving task execution efficiency of the second node.

In at least one implementation, a first node determines a first task including the following step: the first node determines at least two first tasks, where the at least two first tasks are executed by one or more second nodes.

That is, when receiving two or more tasks, the first node may alternatively not decompose the tasks, but directly allocate the tasks to corresponding second nodes.

In at least one implementation, the second task is the first task.

In at least one implementation, a first node determines a first task including the following step:
the first node determines at least two second tasks of the first task, where the at least two second tasks correspond to at least two second nodes, and execution types of the at least two second nodes are coordinated execution, or execution types of the at least two second nodes are single-point execution.

In at least one implementation, the method further includes any one or more of the following:
the first node receives capability information from the second node, where the capability information indicates a capability of the second node to execute a task: the first node sends a resource configuration request to the second node, where the resource configuration request is used to request to perform resource configuration on the second task: the first node receives a second message, where the second message indicates an execution result of the second task: or the first node receives at least two second messages, and combines execution results of the first task based on the at least two second messages, where the second message indicates an execution result of the second task.

In at least one implementation, the second node includes one or more of the following: a second core network device, a second access network device, or a terminal device: the second access network device includes one or more of the following: a base station, a central unit (CU), a distributed unit (DU), a central unit-control plane (CU-CP), and a central unit-user plane (CU-UP); and the second core network device includes one or more of the following: an access and mobility management function (AMF), a session management function (SMF), a user plane function (UPF), a network exposure function (NEF), a network repository function (network repository function, NRF), a policy control function (PCF), unified data management (UDM), an application function (AF), and an authentication server function (AUSF).

In at least one implementation, a protocol layer for interaction between the first core network device and the terminal device is located above a non-access stratum (NAS), or is located in the NAS: a protocol layer for interaction between the first access network device and the terminal device is located above radio resource control (RRC) layer, or is located in the RRC layer; or a protocol layer for interaction between the first access network device and the terminal device is located above a service data adaptation protocol (SDAP) layer, or is located in the SDAP layer.

For example, when the protocol layer for interaction between the first core network device and the terminal device is located above the NAS, logic of various protocol layers is clear. When the protocol layer for interaction between the first core network device and the terminal device is located in the NAS, it can be ensured that a quantity of layers of the protocol stack remains unchanged, and therefore signaling overheads remain unchanged. Descriptions about other protocol layers are not described in detail herein.

In at least one implementation, the terminal device interacts with the DU by using the central unit CU, and a protocol layer for interaction between the terminal device and the CU is located above RRC layer, or a protocol layer for interaction between the terminal device and the CU is located in the RRC layer: or a protocol layer for interaction between the terminal device and the DU is located in a physical (PHY) layer and a media access control (MAC) layer.

In at least one implementation, a protocol layer for interaction between the CU and the DU is located above an F1 interface application protocol (F1AP), is located in the F1AP, or is located above representational state transfer (RST): a protocol layer for interaction between the CU-CP and the CU-UP is located above an E1 interface application protocol (E1AP) layer, is located in the E1AP layer, or is located above representational state transfer (RST): a protocol layer for interaction between the first core network device and the first access network device is located above an Ng interface application protocol (NgAP), is located in the NgAP, is located above a general packet radio system (GPRS) tunneling protocol-user plane (GTUP), is located in the GTP-U layer, or is located above representational state transfer RST: a protocol layer for interaction between the first access network device and the second access network device is located above an Xn interface application protocol (XnAP), is located in the XnAP, or is located above representational state transfer RST: or a protocol layer for interaction between the first core network device and the second core network device is located above representational state transfer RST.

It may be understood that the RST shown in this embodiment of this application may be understood as RST that is based on a service-based architecture (service-based architecture, SBA).

In at least one implementation, the first node sends a first message including the following step:

the first node sends the first message to the second node, where the second node is one of nodes that are determined by the first node and that are configured to execute the first task; and the first node includes the first core network device, and the second node includes the second core network device or the terminal device, or the first node includes the first access network device, and the second node includes the second access network device and the terminal device. Alternatively, the first node sends the first message to the second node by using a forwarding node, where the second node is one of nodes that are determined by the forwarding node and that are configured to execute the first task, the first node includes the first core network device, the forwarding node includes the first access network device, and the second node includes the second access network device and/or the terminal device.

In this embodiment of this application, the forwarding node may be configured to implement a step performed by the first node, and may also be configured to implement a step performed by the second node. For another example, the forwarding node may have both a task execution function and a task managing and controlling function. For another example, the forwarding node may be configured to forward a message, or may be configured to perform secondary decomposition and/or allocation on a task, or the like.

According to a second aspect, an embodiment of this application provides a task processing method. The method includes the following steps.

A second node receives a first message from a first node, where the first message includes identification information of a second task and/or configuration information of the second task, the second task is a subtask of the first task, the first task is a task related to artificial intelligence AI, and the first node includes a first core network device and/or a first access network device; and the second node executes the second task.

In at least one implementation, a second node receives a first message including the following step.

the second node receives the first message sent by the first node, where the second node is one of nodes that are determined by the first node and that are configured to execute the first task; and the first node includes the first core network device, and the second node includes a second core network device or a terminal device, or the first node includes the first access network device, and the second node includes a second access network device and a terminal device. Alternatively, the second node receives, by using a forwarding node, the first message sent by the first node, where the second node is one of nodes that are determined by the forwarding node and that are configured to execute the first task, the first node includes the first core network device, the forwarding node includes the first access network device, and the second node includes a second access network device and/or a terminal device.

In at least one implementation, the method further includes any one or more of the following:
the second node sends capability information, where the capability information indicates a capability of the second node to execute a task: the second node receives a resource configuration request, where the resource configuration request is used to request to perform resource configuration on the second task: or the second node sends a second message, where the second message indicates an execution result of the second task.

In at least one implementation, the second node includes one or more of the following: the second core network device, the second access network device, or the terminal device: the second access network device includes one or more of the following: a base station, a central unit CU, a distributed unit DU, a central unit-control plane CU-CP, and a central unit-user plane CU-UP; and the second core network device includes one or more of the following: an access and mobility management AMF, a session management function SMF, a user plane function UPF, a network exposure function NEF, a network repository function NRF, a policy control function PCF, unified data management UDM, an application function AF, and an authentication server function AUSF.

In at least one implementation, a protocol layer for interaction between the first core network device and the terminal device is located above a non-access stratum NAS or is located in the NAS: a protocol layer for interaction between the first access network device and the terminal device is located above radio resource control RRC layer, or is located in the RRC layer; or a protocol layer for interaction between the first access network device and the terminal device is located above a service data adaptation protocol SDAP layer, or is located in the SDAP layer.

In at least one implementation, the terminal device interacts with the DU by using the central unit CU, and a protocol layer for interaction between the terminal device and the CU is located above RRC layer, or a protocol layer for interaction between the terminal device and the CU is located in the RRC layer: or a protocol layer for interaction between the terminal device and the DU is located in a physical PHY layer and a media access control MAC layer.

In at least one implementation, a protocol layer for interaction between the CU and the DU is located above an F1 interface application protocol F1AP layer, is located in the F1AP layer, or is located above representational state transfer RST: a protocol layer for interaction between the CU-CP and the CU-UP is located above an E1 interface application protocol E1AP layer, is located above the E1AP layer, or is located above representational state transfer RST: a protocol layer for interaction between the first core network device and the first access network device is located above an Ng interface application protocol NgAP layer, is located in the NgAP layer, is located above a general packet radio system GPRS tunneling protocol-user plane GTP-U layer, is located in the GTP-U layer, or is located above presentational state transfer RST layer: a protocol layer for interaction between the first access network device and the second access network device is located above an Xn interface application protocol XnAP, or is located above presentation-state transfer RST: or a protocol layer for interaction between the first core network device and the second core network device is located above representational state transfer RST.

It may be understood that, for related descriptions of the second aspect, refer to the method embodiment shown in the first aspect or the following.

According to a third aspect, an embodiment of this application provides a communication apparatus. The apparatus includes units configured to perform the method in any one of the first aspect or the possible implementations of the first aspect.

According to a fourth aspect, an embodiment of this application provides a communication apparatus. The apparatus includes units configured to perform the method in any one of the second aspect or the possible implementations of the second aspect.

According to a fifth aspect, an embodiment of this application provides a communication apparatus. The apparatus includes:
a processing unit, configured to determine a first task, where the communication apparatus includes a first core network device and/or a first access network device, and the first task is a task related to artificial intelligence AI; and
a transceiver unit, configured to send a first message, where the first message includes identification information of a second task and/or configuration information of the second task, the second task is a subtask of the first task, the second task is executed by a second node, and the second node is one of determined nodes configured to execute the first task.

It may be understood that, that the transceiver unit shown in this embodiment of this application is configured to send a first message may be further understood as the following: The processing unit is configured to control the transceiver unit to send the first message, or the processing unit is configured to send the first message by using the transceiver unit. Descriptions of the processing unit and the transceiver unit are also applicable below.

In at least one implementation, the first message further includes identification information of the first task.

In at least one implementation, a type of the first task includes any one or more of the following: an inference task, a training task, a learning task, a computing task, or a sensing task.

In at least one implementation, the processing unit is specifically configured to determine any one or more of life cycle information of the first task, resource information of the first task, allocation information of the first task, or decomposition information of the first task.

In at least one implementation, the life cycle information of the first task includes any one or more of the following: addition of the first task, modification of the first task, querying of the first task, reporting of the first task, migration of an execution node of the first task, and migration of a management node of the first task: the resource information of the first task includes any one or more of the following: computing power of the first task, an algorithm of the first task, data of the first task, or a connection of the first task: the allocation information of the first task includes any one or more of the following: allocation of an execution node of the first task, allocation of an execution type of the execution node of the first task, and resource allocation of the execution node of the first task; and/or the decomposition information of the first task includes any one or more of the following: a quantity of tasks obtained by decomposing the first task and computing power decomposition of the first task.

In at least one implementation, the processing unit is specifically configured to determine at least two first tasks, where the at least two first tasks are executed by one or more second nodes.

In at least one implementation, the second task is the first task.

In at least one implementation, the processing unit is specifically configured to determine at least two second tasks of the first task, where the at least two second tasks correspond to at least two second nodes, and execution types of the at least two second nodes are coordinated execution, or execution types of the at least two second nodes are single-point execution.

In at least one implementation, the transceiver unit is further configured to receive capability information from the second node, where the capability information indicates a capability of the second node to execute a task: the transceiver unit is further configured to send a resource configuration request to the second node, where the resource configuration request is used to request to perform resource configuration on the second task: the transceiver unit is further configured to receive a second message, where the second message indicates an execution result of the second task: or the transceiver unit is further configured to receive at least two second messages, and combine execution results of the first task based on the at least two second messages, where the second message indicates an execution result of the second task.

In this embodiment of this application, that the transceiver unit is configured to receive capability information may also be understood as the following: The processing unit controls the transceiver unit to receive the capability information, or the processing unit receives the capability information by using the transceiver unit. Descriptions of the processing unit and the transceiver unit are also applicable below.

In at least one implementation, the second node includes one or more of the following: a second core network device, a second access network device, or a terminal device: the second access network device includes one or more of the following: a base station, a central unit (CU), a distributed unit (DU), a central unit-control plane (CU-CP), and a central unit-user plane (CU-UP); and the second core network device includes one or more of the following: an access and mobility management function (AMF), a session management function (SMF), a user plane function (UPF), a network exposure function (NEF), a network repository function (NRF), a policy control function (PCF), unified data management (UDM), an application function (AF), and an authentication server function (AUSF).

In at least one implementation, a protocol layer for interaction between the first core network device and the terminal device is located above a non-access stratum (NAS), or is located in the NAS: a protocol layer for interaction between the first access network device and the terminal device is located above radio resource control (RRC) layer, or is located in the RRC layer; or a protocol layer for interaction between the first access network device and the terminal device is located above a service data adaptation protocol (SDAP) layer, or is located in the SDAP layer.

In at least one implementation, the terminal device interacts with the DU by using the central unit CU, and a protocol layer for interaction between the terminal device and the CU is located above RRC layer, or a protocol layer for interaction between the terminal device and the CU is located in the RRC layer: or a protocol layer for interaction between the terminal device and the DU is located in a physical (PHY) layer and a media access control (MAC) layer.

In at least one implementation, a protocol layer for interaction between the CU and the DU is located above an F1 interface application protocol (F1AP), is located in the F1AP, or is located above representational state transfer (RST): a protocol layer for interaction between the CU-CP and the CU-UP is located above an E1 interface application protocol (E1 application protocol, E1AP) layer, is located in the E1AP layer, or is located above representational state transfer RST: a protocol layer for interaction between the first core network device and the first access network device is located above an Ng interface application protocol NgAP, is located in the NgAP, is located above a general packet radio system (GPRS) tunneling protocol-user plane (GTP-U) layer, is located in the GTP-U layer, or is located above representational state transfer RST: or a protocol layer for interaction between the first access network device and the second access network device is located above an Xn interface application protocol (XnAP), is located in the XnAP, or is located above representational state transfer RST: or a protocol layer for interaction between the first core network device and the second core network device is located above representational state transfer RST.

In at least one implementation, the transceiver unit is specifically configured to send the first message to the second node, where the second node is one of nodes that are determined by the communication apparatus and that are configured to execute the first task; and the communication apparatus includes the first core network device, and the second node includes the second core network device or the terminal device, or the communication apparatus includes the first access network device, and the second node includes the second access network device and the terminal device. Alternatively, the transceiver unit is further configured to send the first message to the second node by using a forwarding node, where the second node is one of nodes that are determined by the forwarding node and that are configured to execute the first task, the communication apparatus includes the first core network device, the forwarding node includes the first access network device, and the second node includes the second access network device and/or the terminal device.

For a specific description of the communication apparatus in the fifth aspect, refer to the apparatus embodiment shown in the first aspect or the following.

According to a sixth aspect, an embodiment of this application provides a communication apparatus. The apparatus includes:
a transceiver unit, configured to receive a first message from a first node, where the first message includes identification information of a second task and/or configuration information of the second task, the second task is a subtask of the first task, the first task is a task related to artificial intelligence AI, and the first node includes a first core network device and/or a first access network device; and a processing unit, configured to execute the second task.

In at least one implementation, the transceiver unit is specifically configured to receive the first message sent by the first node, where the communication apparatus is one of nodes that are determined by the first node and that are configured to execute the first task; and the first node includes the first core network device, and the communication apparatus includes a second core network device or a terminal device, or the first node includes the first access network device, and the communication apparatus includes a second access network device and a terminal device. Alternatively, the transceiver unit is specifically configured to receive, by using a forwarding node, the first message sent by the first node, where the communication apparatus is one of nodes that are determined by the forwarding node and that are configured to execute the first task, the first node includes the first core network device, the forwarding node includes the first access network device, and the communication apparatus includes a second access network device and/or a terminal device.

In at least one implementation, the transceiver unit is specifically configured to send capability information, where the capability information indicates a capability of the communication apparatus to execute a task: the transceiver unit is specifically configured to receive a resource configuration request, where the resource configuration request is used to request to perform resource configuration on the second task: or the transceiver unit is specifically configured to send a second message, where the second message indicates an execution result of the second task.

In at least one implementation, the communication apparatus includes one or more of the following: the second core network device, the second access network device, or the terminal device: the second access network device includes one or more of the following: a base station, a central unit CU, a distributed unit DU, a central unit-control plane CU-CP, and a central unit-user plane CU-UP; and the second core network device includes one or more of the following: an access and mobility management AMF, a session management function SMF, a user plane function UPF, a network exposure function NEF, a network repository function NRF, a policy control function PCF, unified data management UDM, an application function AF, and an authentication server function AUSF.

In at least one implementation, a protocol layer for interaction between the first core network device and the terminal device is located above a non-access stratum NAS or is located in the NAS: a protocol layer for interaction between the first access network device and the terminal device is located above radio resource control RRC layer, or is located in the RRC layer; or a protocol layer for interaction between the first access network device and the terminal device is located above a service data adaptation protocol SDAP layer, or is located in the SDAP layer.

In at least one implementation, the terminal device interacts with the DU by using the central unit CU, and a protocol layer for interaction between the terminal device and the CU is located above RRC layer, or a protocol layer for interaction between the terminal device and the CU is located in the RRC layer: or a protocol layer for interaction between the terminal device and the DU is located in a physical PHY layer and a media access control MAC layer.

In at least one implementation, a protocol layer for interaction between the CU and the DU is located above an F1 interface application protocol F1AP, is located in the F1AP, or is located above representational state transfer RST: a protocol layer for interaction between the CU-CP and the CU-UP is located above an E1 interface application protocol E1AP layer, is located above the E1AP layer, or is located above representational state transfer RST layer: a protocol layer for interaction between the first core network device and the first access network device is located above an Ng interface application protocol NgAP layer, is located in the NgAP layer, is located above a general packet radio system GPRS tunneling protocol-user plane GTP-U layer, is located in the GTP-U layer, or is located above presentational state transfer RST: a protocol layer for interaction between the first access network device and the second access network device is located above an Xn interface application protocol XnAP, or is located above presentation-state transfer RST: or a protocol layer for interaction between the first core network device and the second core network device is located above representational state transfer RST.

It may be understood that for specific descriptions of the sixth aspect, refer to the apparatus embodiment shown in the first aspect, the second aspect, or the following.

According to a seventh aspect, an embodiment of this application provides a communication apparatus. The communication apparatus includes a processor, configured to perform the method in any one of the first aspect or the possible implementations of the first aspect. Alternatively, the processor is configured to execute a program stored in a memory. When the program is executed, the method in any one of the first aspect or the possible implementations of the first aspect is performed.

In at least one implementation, the memory is located outside the communication apparatus.

In at least one implementation, the memory is located inside the communication apparatus.

In this embodiment of this application, the processor and the memory may alternatively be integrated into one device. In other words, the processor and the memory may alternatively be integrated together.

In at least one implementation, the communication apparatus further includes a transceiver. The transceiver is configured to receive a signal or send a signal. For example, the transceiver may be configured to send a first message and the like.

According to an eighth aspect, an embodiment of this application provides a communication apparatus. The communication apparatus includes a processor, configured to perform the method in any one of the second aspect or the possible implementations of the second aspect. Alternatively, the processor is configured to execute a program stored in a memory. When the program is executed, the method in any one of the second aspect or the possible implementations of the second aspect is performed.

In at least one implementation, the memory is located outside the communication apparatus.

In at least one implementation, the memory is located inside the communication apparatus.

In this embodiment of this application, the processor and the memory may alternatively be integrated into one device. In other words, the processor and the memory may alternatively be integrated together.

In at least one implementation, the communication apparatus further includes a transceiver. The transceiver is configured to receive a signal or send a signal. For example, the transceiver may be configured to receive a first message and the like.

According to a ninth aspect, an embodiment of this application provides a communication apparatus. The communication apparatus includes a logic circuit and an interface, the logic circuit is coupled to the interface, the logic circuit is configured to determine a first task, and the interface is configured to output a first message.

For example, the interface is configured to input a second message and the like.

It may be understood that for descriptions of the first task, the first message, and the like, refer to the descriptions of the first aspect or the second aspect, or refer to the following embodiments. Details are not described herein.

According to a tenth aspect, an embodiment of this application provides a communication apparatus. The communication apparatus includes a logic circuit and an interface, the logic circuit is coupled to the interface, the interface is configured to input a first message, and the logic circuit is configured to execute a second task.

It may be understood that for descriptions of the first message, the first task, the second task, and the like, refer to the descriptions of the first aspect or the second aspect, or refer to the following embodiments. Details are not described herein.

According to an eleventh aspect, an embodiment of this application provides a computer-readable storage medium. The computer-readable storage medium is configured to store a computer program. When the computer program runs on a computer, the method according to any one of the first aspect or the possible implementations of the first aspect is enabled to be performed.

According to a twelfth aspect, an embodiment of this application provides a computer-readable storage medium. The computer-readable storage medium is configured to store a computer program. When the computer program runs on a computer, the method according to any one of the second aspect or the possible implementations of the second aspect is enabled to be performed.

According to a thirteenth aspect, an embodiment of this application provides a computer program product. The computer program product includes a computer program or computer code. When the computer program product or the computer code runs/is run on a computer, the method according to any one of the first aspect or the possible implementations of the first aspect is enabled to be performed.

According to a fourteenth aspect, an embodiment of this application provides a computer program product. The computer program product includes a computer program or computer code. When the computer program product or the computer code runs/is run on a computer, the method according to any one of the second aspect or the possible implementations of the second aspect is enabled to be performed.

According to a fifteenth aspect, an embodiment of this application provides a computer program. When the computer program runs on a computer, the method according to any one of the first aspect or the possible implementations of the first aspect is performed.

According to a sixteenth aspect, an embodiment of this application provides a computer program. When the computer program runs on a computer, the method according to any one of the second aspect or the possible implementations of the second aspect is performed.

According to a seventeenth aspect, an embodiment of this application provides a wireless communication system. The wireless communication system includes a first node and a second node. The first node is configured to perform the method shown in any one of the first aspect or the possible implementations of the first aspect. The second node is configured to perform the method shown in any one of the second aspect or the possible implementations of the second aspect.

### BRIEF DESCRIPTION OF DRAWINGS

FIG. 1 is a schematic diagram of a network architecture according to at least one embodiment of this application:

FIG. 2a is a schematic diagram of protocol stacks of a control plane (CP) and a user plane (UP) according to at least one embodiment of this application:

FIG. 2b is a schematic diagram of deployment of base stations according to at least one embodiment of this application:

FIG. 2c is a schematic diagram of a protocol stack between different network elements according to at least one embodiment of this application:

FIG. 2d is a schematic diagram of an interface between network elements according to at least one embodiment of this application:

FIG. 3 is a schematic flowchart of a task processing method according to at least one embodiment of this application:

FIG. 4a to FIG. 4c are each a schematic diagram of deployment of a first node and a second node according to at least one embodiment of this application:

FIG. 5a and FIG. 5b are each a schematic diagram of a scenario of task decomposition and task allocation according to at least one embodiment of this application:

FIG. 6a and FIG. 6b are each a schematic diagram of a coordinated type according to at least one embodiment of this application:

FIG. 7a and FIG. 7b are each a schematic diagram of a network architecture according to at least one embodiment of this application:

FIG. 8a and FIG. 8b are each a schematic diagram of a scenario of a task processing method according to at least one embodiment of this application:

FIG. 9a is a schematic diagram of different management methods of a session and a task according to at least one embodiment of this application:

FIG. 9b is a schematic diagram of functions of a first node and a second node according to at least one embodiment of this application:

FIG. 10 is a schematic diagram of interaction between different network elements according to at least one embodiment of this application:

FIG. 11a to FIG. 11h are each a schematic diagram of a protocol layer for interaction between different network elements according to at least one embodiment of this application:

FIG. 12a is a schematic diagram of a protocol layer for interaction between different network elements according to at least one embodiment of this application:

FIG. 12b is a schematic diagram of three protocol stacks according to at least one embodiment of this application:

FIG. 13a to FIG. 13c are each a schematic diagram of a protocol layer for interaction between different network elements according to at least one embodiment of this application:

FIG. 14a and FIG. 14b are each a schematic flowchart of a task processing method according to at least one embodiment of this application:

FIG. 15a is a schematic diagram of a network architecture according to at least one embodiment of this application:

FIG. 15b is a schematic flowchart of a task processing method according to at least one embodiment of this application:

FIG. 16a is a schematic diagram of a network architecture according to at least one embodiment of this application:

FIG. 16b is a schematic flowchart of a task processing method according to at least one embodiment of this application; and

FIG. 17 to FIG. 19 are each a schematic diagram of a structure of a communication apparatus according to at least one embodiment of this application.

### DESCRIPTION OF EMBODIMENTS

To make the objectives, technical solutions, and advantages of this application clearer, this application is further described with reference to the accompanying drawings.

Terms “first”, “second”, and the like in the specification, claims, and accompanying drawings of this application are merely used to distinguish between different objects, and are not used to describe a specific order. In addition, terms such as “include” and “have” and any other variants thereof are intended to cover a non-exclusive inclusion. For example, processes, methods, systems, products, devices, or the like that include a series of steps or units are not limited to listed steps or units, but instead, optionally further include steps or units that are not listed, or optionally further include other steps or units inherent to these processes, methods, products, or devices.

“Embodiments” mentioned herein mean that specific features, structures, or characteristics described in combination with the embodiments may be included in at least one embodiment of this application. The phrase shown in various locations in the specification may not necessarily refer to a same embodiment, and is not an independent or optional embodiment exclusive from another embodiment. It may be understood explicitly and implicitly by a person skilled in the art that the embodiments described herein may be combined with other embodiments.

In this application, “at least one (item)” means one or more, “a plurality of” means two or more, “at least two (items)” means two or three or more, and “and/or” is used to describe an association relationship between associated objects, which indicates that three relationships may exist. For example, “A and/or B” may indicate: only A exists, only B exists, and both A and B exist. A and B may be singular or plural. The character “/” generally indicates an “or” relationship between the associated objects. “At least one of the following” or a similar expression thereof means any combination of these items. For example, at least one of a, b, or c may represent: a, b, c, “a and b”, “a and c”, “b and c”, or “a and b and c”.

A method provided in this application may be applied to various communication systems, for example, an internet of things (IoT) system, a narrowband internet of things (NB-IoT) system, a long term evolution (LTE) system, a 5th-generation (5G) communication system, and a new communication system (for example, 6G) emerging in future communication development. In addition, the method provided in this application may be further applied to a wireless local area network (WLAN) system, for example, wireless fidelity (Wi-Fi) and the like.

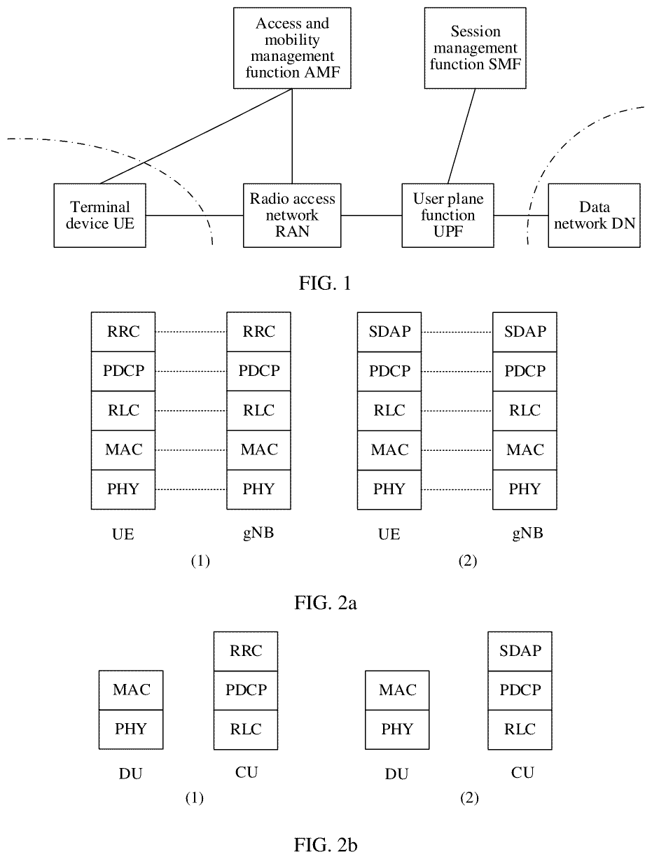

The technical solutions provided in this application may be further applied to machine type communication (MTC), a long-term evolution machine type communication (LTE-M) technology, a device-to-device (D2D) network, a machine-to-machine (M2M) network, an internet of things (IoT) network, an industrial internet, or another network. The IoT network may include, for example, an internet of vehicles. Communication manners in an internet of vehicles system are collectively referred to as vehicle-to-everything (V2X, where X may represent any thing). For example, the V2X may include vehicle-to-vehicle (V2V) communication, vehicle-to-infrastructure (V2I) communication, vehicle-to-pedestrian (V2P) communication, or vehicle-to-network (V2N) communication. For example, in FIG. 1 shown below, terminal devices may communicate with each other by using the D2D technology, the M2M technology, the V2X technology, or the like.

For example, the following describes a network architecture in this application by using a 5G communication system as an example.

FIG. 1 is a schematic diagram of a network architecture according to an embodiment of this application. The network architecture shown in FIG. 1 is, for example, a 5G network architecture that is based on a service-based architecture and that is defined in a 3rd generation partnership project (3GPP) standardization process. As shown in FIG. 1, the network architecture may include at least three parts: a terminal device part, an operator network part, a data network (DN) part, and the like.

For example, the data network (DN) may also be referred to as a packet data network (PDN), and is usually a network located outside an operator network, for example, a third-party network. For example, the operator network may access a plurality of data networks, and a plurality of services may be deployed in the data network, to provide a data service and/or a voice service, and the like for a terminal device. A specific representation form of the third-party network may be specifically determined based on an actual application scenario. This is not limited in this application.

For example, the terminal device part includes a terminal device, and the terminal device may also be referred to as user equipment (user equipment, UE), a terminal, a user terminal, or the like. The terminal device is a device that has a wireless transceiver function. For example, the terminal device may communicate with one or more core network (CN) devices (or may be referred to as a core device) through an access network device (or may be referred to as an access device) in a radio access network (RAN). In a possible implementation, the terminal device may be deployed on land, including indoors or outdoors, or in a handheld manner, a wearable manner, or an in-vehicle manner, or may be deployed on a water surface, for example, on a ship. In another possible implementation, the terminal device may be a handheld device, an in-vehicle device, a wearable device, a sensor, a terminal in the internet of things, a terminal in the internet of vehicles, an uncrewed aerial vehicle, a terminal device in any form in a 5th-generation (5G) network or a future network, or the like that has a wireless communication function. This is not limited in this application.

It may be understood that the terminal device shown in this application may not only include a vehicle (for example, an entire vehicle) in the internet of vehicles, but also include an in-vehicle device or an in-vehicle terminal (including a telematics box (telematics box, T-box) or a host in an internet of vehicles system) in the internet of vehicles. A specific form of the terminal device applied to the internet of vehicles is not limited in this application. For ease of description, the following describes the method in this application by using an example in which the terminal device is UE.

For example, the operator network part may include an access and mobility management function (AMF), a session management function (SMF), a user plane function (UPF), a radio access network (RAN), and the like. In the foregoing operator network, other parts than the radio access network part may also be referred to as a core network (CN) part or a core network part. The access network device may be deployed in the radio access network, to provide a wireless communication service for the terminal device. The access network device may also be referred to as an access device, a RAN device, or the like. For example, the core network may further include a network exposure function (NEF), a network repository function (NRF), a policy control function (PCF), unified data management (UDM), an application function (AF), an authentication server function (AUSF), and the like. It may be understood that, for other network elements in the core network, details are not described in embodiments of this application. It may be understood that, with evolution of standard technologies, the AMF, the SMF, or the UPF shown in this application may have other evolutions. For example, the AMF may be evolved into a case in which an access function and a mobility management function are separately deployed, or the AMF, the SMF, and the UPF may have other names. For this, the AMF, the SMF, and the UPF shown below should not be understood as a limitation on embodiments of this application.

For example, the access network device may be a next-generation NodeB (gNB), a next-generation evolved NodeB (ng-eNB), an access network device in future 6G communication, or the like. The access network device may be any device that has a wireless transceiver function, and includes but is not limited to the foregoing base stations (including a base station deployed on a satellite). The access network device may alternatively be an apparatus that has a base station function in a sixth generation communication system. Optionally, the access network device may be an access node, a wireless relay node, a wireless backhaul node, or the like in a wireless local area network (WLAN) system. Optionally, the access network device may be a radio controller in a cloud radio access network (CRAN) scenario. Optionally, the access network device may be a wearable device, an in-vehicle device, or the like. Optionally, the access network device may alternatively be a small cell, a transmission and receiving node (TRP) (or may be referred to as a transmission point), or the like. It may be understood that the access network device may alternatively be a base station, a satellite, or the like in a future evolved public land mobile network (PLMN). The access network device may alternatively be a device or the like that bears a base station function in a non-terrestrial communication system, D2D, V2X, or M2M. A specific type of the access network device is not limited in this application. In systems of different radio access technologies, names of devices that have an access network device function may be different.

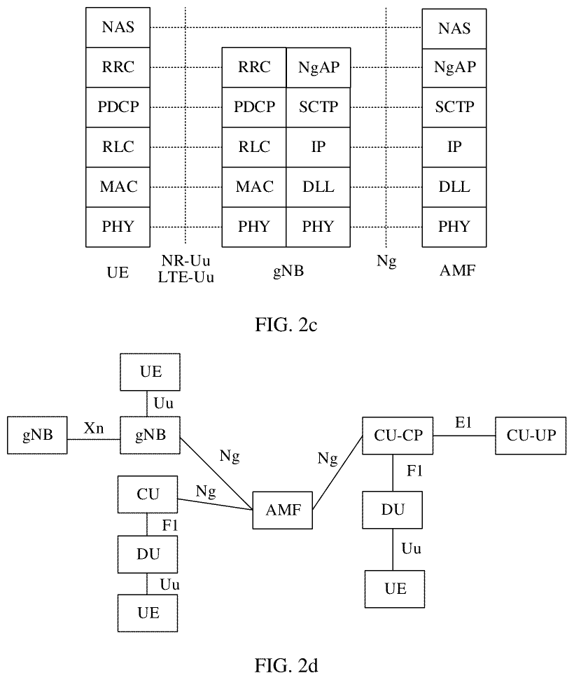

FIG. 2a is a schematic diagram of protocol stacks of a control plane (control plane) and a user plane (user plane) according to an embodiment of this application. As shown in FIG. 2a, layers of a terminal device and an access network device may be connected to each other, to transfer information. (1) in FIG. 2a shows control plane protocols of a terminal device and an access network device. For example, the control plane protocol may include a physical (physical, PHY) layer, a media access control (MAC) layer, a radio link control (RLC) layer, a packet data convergence protocol (PDCP), and radio resource control (RRC). (2) in FIG. 2a shows user plane protocols of a terminal device and an access network device. For example, the user plane protocol includes PHY, MAC, RLC, PDCP, and a service data adaptation protocol (SDAP).

In some deployments, as shown in FIG. 2b, a base station (for example, a gNB) may include a central unit (CU) and a distributed unit (DU). For example, the base station may include the CU and the DU, to be specific, functions of the base station in the access network are split, some functions of the base station are deployed on the CU, and remaining functions of the base station are deployed on the DU. A plurality of DUs may alternatively share one CU, to reduce costs and facilitate network expansion. As shown in (1) in FIG. 2b, a CU and a DU may be split based on a protocol stack. RRC, PDCP, and RLC are deployed on the CU, and MAC and PHY are deployed on the DU. As shown in (2) in FIG. 2b, SDAP, PDCP, and RLC are deployed on a CU, and MAC and PHY are deployed on a DU.

In some other deployments, the CU may alternatively be divided into a CU-CP and a CU-UP. The CU-CP is responsible for a control plane function, and mainly includes RRC and PDCP (for example, may also be referred to as PDCP-C) corresponding to the control plane. The PDCP-C is mainly responsible for data encryption and decryption, integrity protection, data transmission, and the like on the control plane. The CU-UP is responsible for a user plane function, and mainly includes SDAP and PDCP (for example, may also be referred to as PDCP-U) corresponding to the user plane. Different deployment manners of the base station shown in this application are merely examples. During specific implementation, the base station may alternatively be deployed in another manner. Therefore, a deployment manner of the base station shown below should not be understood as a limitation on embodiments of this application. With evolution of standard technologies, this application is also applicable when a base station has different deployment manners. The gNB shown in this embodiment of this application may alternatively be replaced with xNB, where x represents different representations of base stations in different standard networks. For example, the xNB is an eNB in a 4G network, and the xNB is a gNB in a 5G network.

It may be understood that, for ease of distinguishing between different deployment manners of the base station, the base station described below may be understood as a device, for example, a gNB or an eNB, that has a base station function and whose function is not split. Therefore, the base station, the CU, the DU, and the like shown below may be understood as different devices.

FIG. 2c is a schematic diagram of a protocol stack between different network elements according to an embodiment of this application. As shown in FIG. 2c, a protocol stack for interaction between an AMF and a gNB includes an NG interface application protocol (NgAP) (which may also be referred to as an NGAP, an Ng-AP, or the like), a stream control transmission protocol (SCTP), an internet protocol (IP), a data link layer (DLL), and a PHY from top to bottom. As shown in FIG. 2c, when interaction is performed between the AMF and UE, the interaction may be performed by using a non-access stratum (NAS). An interface between the UE and the gNB may include an air interface, for example, an LTE-Uu interface or an NR-Uu interface, and an interface between the gNB and the AMF may include an Ng interface.

FIG. 2d is a schematic diagram of an interface between network elements according to an embodiment of this application. As shown in FIG. 2d, an interface between UE and a gNB includes a Uu interface, indicating that the UE and the gNB may be connected through the Uu interface. An interface between gNBs includes an Xn interface, indicating that the gNBs may be connected through the Xn interface. An interface between the gNB and an AMF includes an Ng interface, an interface between a CU and a DU includes an F1 interface, and an interface between the DU and the UE includes a Uu interface. For another example, an interface between the AMF and a CU-CP includes an Ng interface, an interface between the CU-CP and a CU-UP includes an E1 interface, and an interface between the CU-CP and the DU includes an F1 interface. It may be understood that, for example, a protocol layer for interaction between the CU and the DU includes an F1 interface application protocol (F1AP) (which may also be referred to as F1-AP), and a protocol layer for interaction between the CU-CP and the CU-UP includes an E1 interface application protocol (E1AP) (which may also be referred to as E1-AP).

For example, in some deployments, when the gNB is divided into a CU and a DU, the CU may represent that the gNB is connected to a core network through an Ng interface, and the CU represents that the gNB is connected to another gNB through an Xn interface. It may be understood that the foregoing types of base stations, interfaces, or protocol stacks are merely examples. During specific implementation, there may be another type of base station, another interface, another protocol stack, or the like. This is not limited in this application.

It should be noted that a protocol stack for interaction between two network elements shown in this application is shown based on a fifth generation communication system. With evolution of the communication system, the protocol stack for interaction between the network elements may change, and/or the network elements shown in this application may also change (for example, function splitting and/or combination are performed). Therefore, all protocol stacks or interfaces that have functions similar to those shown in FIG. 2a to FIG. 2d fall within the protection scope of this application.

It may be understood that the method provided in this application is applicable to both a homogeneous network scenario and a heterogeneous network scenario. In addition, there is no limitation on a transmission point, for example, transmission may be collaborative multipoint transmission between macro base stations, between micro base stations, and between a macro base station and a micro base station. For another example, the method provided in this application is applicable to both a frequency division duplexing (FDD) system and/or a time division duplexing (TDD) system. For another example, the method provided in this application is applicable to a low-frequency scenario (for example, lower than 6G Hz, or referred to as sub 6G), or is applicable to a high-frequency scenario (for example, higher than 6G Hz), a terahertz scenario, an optical communication scenario, or the like.

A network data analytics function (NWDAF) in a 5G network may be used to support artificial intelligence (AI), mainly collects and analyzes data at an application layer, and provides a service and interface invoking for an external system. In addition, an operation and maintenance (OAM) network element in the 5G network also has a similar management data analytics function (MDAF); and can support data collection and analysis of management data, and provide a service and interface invoking for an external system. However, in the foregoing AI-related research project, an AI-related procedure and functions are not standardized. This application provides a task processing method and a related product, so that AI task management efficiency can be effectively improved by standardizing an AI task.

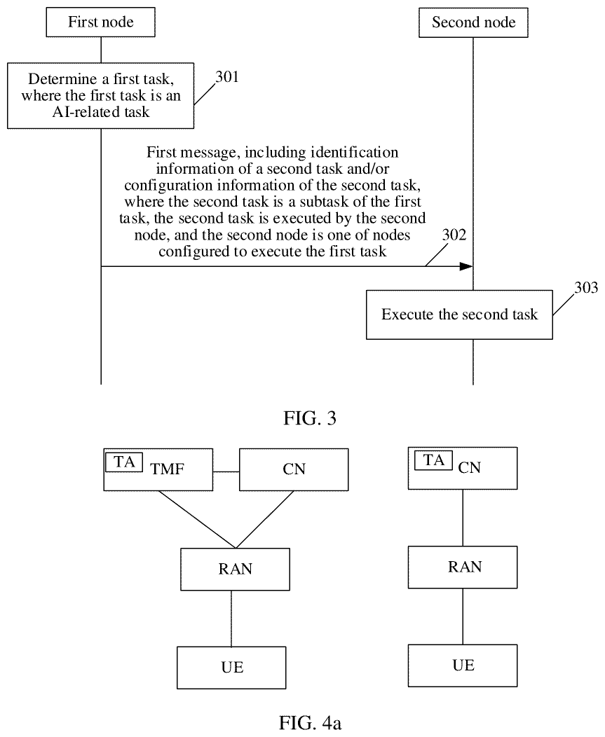

FIG. 3 is a schematic flowchart of a task processing method according to an embodiment of this application. The following describes in detail a first node and a second node in the task processing method.

Implementation 1: The first node includes a first core network device.

The first node is deployed in the first core network device, the first node is included in the first core network device, or the first node includes the first core network device, or the like. A description of a relationship between the first core network device and the first node is not limited in this embodiment of this application.

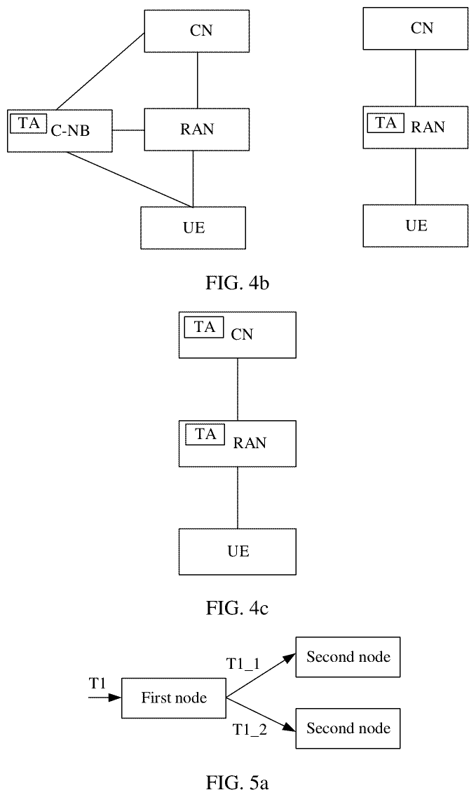

It is assumed that both a network element (which may also be briefly referred to as a CN network element) in a core network and a network element (which may also be briefly referred to as a RAN network element) in an access network may be used as a second node. In this case, both the network element in the core network and the network element in the access network may be centrally managed and/or controlled by the first core network device. For example, the first core network device may be a core network device in the operator network part shown in FIG. 1 (as shown in the figure at a right side of FIG. 4a): or the first core network device may be an added core network element (as shown in the figure at a left side of FIG. 4a). As shown in FIG. 4a, a task management function (TMF) in FIG. 4a may be understood as an added core network element, and a task anchor (TA) shown in the TMF may be understood as that the TMF can implement a step, a function, or the like performed by the first node shown in embodiments of this application. The TA in the CN shown in FIG. 4a may be understood as that the CN can implement a step, a function, or the like performed by the first node shown in embodiments of this application.

For example, the first core network device may be one of an AMF, an SMF, or a UPF. For another example, the first core network device may alternatively be an added core network element, for example, a TMF. For another example, the first core network device may be an AMF that has a specific type of feature. For example, the first core network device may be a network element that has an access and mobility management function in a 6G network. For another example, the first core network device may be a network element that has an access and mobility management function and that can process an AI task. It may be understood that, for descriptions of the UPF, the SMF, or the TMF, refer to descriptions of the AMF. Details are not described herein. For another example, the first core network device may be a specific AMF, a specific UPF, a specific SMF, a specific TMF, or the like. It should be noted that the first core network device may further include one or more of an NEF, an NRF, a PCF, UDM, an AF and an AUSF. Details are not described herein.

It may be understood that the first core network device may also be referred to as a control core network (C-CN) or a core network task anchor (CN TA). For ease of differentiation, the following uses an example in which the first core network device is represented by CN TA and the second core network device is represented by CN to describe a method, an implementation, or the like in embodiments of this application.

Correspondingly, C the second node may include any one or more of the following: a second core network device, a second access network device, and UE. The second access network device includes a base station (for example, a gNB), a CU, a DU, a CU-CP, and a CU-UP. For example, a difference between the first core network device and the second core network device lies in that the first core network device can perform a step performed by the first node, or can implement a related function that can be implemented by the first node. To be specific, the first core network device is configured to perform related management, control, or the like on a task, and the second core network device is configured to execute a specific task based on management or control of the first core network device. For example, if the first core network device is a TMF, the second core network device is an AMF, an SMF, a UPF, or the like. For another example, if the first core network device is an AMF, the second core network device may be an SMF, a UPF, or the like. For another example, when the first core network device is a specific AMF, the second core network device may be another AMF.

It should be noted that when the first node includes the first core network device, both the first access network device and the second access network device shown in this embodiment of this application may be centrally managed and controlled by the first core network device. Alternatively, it may be understood as that when the first node includes the first core network device, the first access network device and the second access network device may not be specifically distinguished in this embodiment of this application.

Implementation 2: The first node includes a first access network device.

The first node is deployed in the first access network device, the first node is included in the first access network device, or the first node includes the first access network device, or the like. A description of a relationship between the first access network device and the first node is not limited in this embodiment of this application.

It is assumed that both a CN network element and a RAN network element may be used as a second node. In this case, a CN computing power node, a RAN computing power node, and the like may all be centrally managed and/or controlled by the first access network device. For example, the first access network device may be the access network device in the operator network part shown in FIG. 1 (as shown in the figure at a right side of FIG. 4b): or the first access network device may be an added access network element (as shown in the figure at a left side of FIG. 4b). As shown in FIG. 4b, a control NodeB (C-NB) in FIG. 4b may be understood as an added access network element. A task anchor (TA) shown in the C-NB may be understood as that the C-NB can implement a step, a function, or the like performed by the first node shown in embodiments of this application. A TA in a RAN shown in FIG. 4a may be understood as that the RAN can implement a step, a function, or the like performed by the first node shown in embodiments of this application.

For example, the first access network device may be one of a gNB (only an example), a CU, a DU, a CU-UP, or a CU-CP. For another example, the first access network device may be a network element that has a base station function and that has a feature of a specific type. For example, the first access network device may be a network element that can process an AI task and that has a base station function. For another example, the first access network device may be a specific base station, a specific CU, a specific CU-CP, or the like. It may be understood that the first access network device may also be referred to as a radio access network task anchor (RAN TA). For ease of differentiation, the following uses an example in which the first access network device is represented by RAN TA and the second access network device is represented by RAN to describe a method, an implementation, or the like in embodiments of this application.

Correspondingly, the second node may include any one or more of the following: a second core network device, a second access network device, and UE. The second access network device includes a base station (for example, a gNB), a CU, a DU, a CU-CP, and a CU-UP. It may be understood that the examples of the second access network device shown herein may not include the first access network device, to be specific, the second access network device may be another access network device other than the first access network device. The second core network device may include any one or more of an AMF, an SMF, a UPF, an NEF, an NRF, a PCF, UDM, an AF and an AUSF. It may be understood that, for related descriptions of the first access network device and the second access network device, refer to the descriptions of the first core network device and the second core network device. Details are not described herein. It may be understood that, for example, when the first access network device is a CU, the second node cannot be a CU but may be a DU, a CU-CP, a CU-UP, or the like. For another example, when the first access network device is a CU of a specific type, the second node may not be a CU of this specific type. For another example, when the first access network device is a gNB, the second access network device may be an eNB or the like. Examples are not described herein one by one.

It should be noted that when the first node includes the first access network device, both the first core network device and the second core network device shown in this embodiment of this application may be centrally managed and controlled by the first core network device. Alternatively, it may be understood as that when the first node includes the first access network device, the first core network device and the second core network device may not be specifically distinguished in this embodiment of this application.

Implementation 3: The first node includes a first core network device and a first access network device.

There may be two manners for understanding that the first node includes the first core network device and the first access network device: 1. The first node is divided into two parts, for example, a first part and a second part, based on different functions of the first node. For example, the first part of the first node is deployed on the first core network device, and the second part of the first node is deployed on the first access network device. For a manner of splitting based on the functions of the first node, refer to the foregoing description of dividing the base station into a CU, a DU, and the like. 2. Both the first core network device and the first access network device are first nodes. In other words, both the first core network device and the first access network device may be configured to implement a function and/or a step performed by the first node shown in embodiments of this application.

Because both the first core network device and the first access network device may be first nodes, it logically indicates that both the first core network device and the first access network device can implement a step, a function, or the like performed by the first node shown in embodiments of this application. Therefore, a core network corresponding to the CN TA and an access network corresponding to the RAN TA may be considered as different domains. In this case, other core network devices than the CN TA in network elements of the core network are centrally managed by the CN TA, and other access network devices than the RAN TA in the access network are centrally managed by the RAN TA. In this way, core network domain autonomy and access network domain autonomy, namely, domain-based autonomy, can be implemented. Optionally, the UE may be managed by both the first core network device and the first access network device, may be managed by only the first core network device, or may be managed by only the first access network device. Optionally, usually, the CN may simultaneously manage one or more RANs. Therefore, in this embodiment of this application, during domain-based autonomy, one CN TA may also simultaneously manage one or more RAN TAs. For example, the CN TA may separately allocate a task to the one or more RAN TAs.

To further understand the first node and the second node shown in embodiments of this application, for example, the first node and the second node may be understood as follows: The first node may be configured to manage and control a task (for example, manage and control a life cycle of a task, manage and control a resource of a task, decompose a task, or allocate a task), and the second node may be configured to execute a task. For example, the first node may be configured to manage and control a task resource and the like of the second node, to perform life cycle management and control on each task. For example, the second node may be configured to execute an inference task, an AI training task, or the like, to obtain an execution result. It may be understood that, for steps or functions that can be implemented by the first node and the second node, further refer to a method shown in the following.

Based on the first node and the second node shown above, as shown in FIG. 3, a task processing method provided in this embodiment of this application includes the following steps:
301: A first node determines a first task, where the first task is an AI-related task.

The first task is the AI-related task. In other words, the first node and the second node shown in this embodiment of this application may be configured to process the AI-related task. For example, a scope of AI may include any one or more of the following: language learning and processing, knowledge representation, intelligent search, inference, planning, machine learning, knowledge acquisition, combination scheduling, sensing, pattern recognition, a logical program design, soft computing, inexact and uncertain management, an artificial life, a neural network, a complex system, a genetic algorithm, a human thinking manner, and the like. For example, a type of the first task shown in this embodiment of this application may include any one or more of the following: an inference task, a training task, a learning task, a computing task, or a sensing task. It may be understood that for descriptions of the first node, the first core network device, and the first access network device, refer to the foregoing descriptions of FIG. 4a to FIG. 4c. Details are not described herein.

For specific descriptions of determining the first task by the first node, there are the following three different descriptions in this embodiment of this application.

In a first possible implementation, that a first node determines a first task includes any one or more of the following: The first node determines life cycle information of the first task, the first node determines resource information of the first task, the first node determines allocation information of the first task, or the first node determines decomposition information of the first task. That is, the first node determines any one or more of the life cycle information, the resource information, the allocation information, or the decomposition information of the first task.

For example, the life cycle information of the first task includes any one or more of the following: addition of the first task, modification of the first task, querying of the first task, reporting of the first task, migration of an execution node of the first task, and migration of a management node of the first task. For example, the addition of the first task may be understood as adding a configuration parameter of the first task or the like, for example, adding a configuration parameter of a computing task, an inference task, a sensing task, or the like. The modification of the first task may be understood as modification of a configuration parameter of an existing first task, for example, modifying a configuration parameter of an existing computing task, inference task, sensing task, or the like. The querying of the first task may be understood as querying a status, a progress, or the like of the first task, for example, querying a status or progress of an existing computing task, inference task, or sensing task. The reporting of the first task may be understood as reporting an execution result of the first task. For example, the first node may report the execution result of the first task to a trigger node. The migration of the execution node of the first task may be understood as migrating a node that executes the first task to the second node. The migration of the management node of the first task may be understood as migrating the first node and/or migrating a forwarding node. For example, when the first access network device performs cell handover, the management node of the first task may be handed over from a source base station to a target base station. It should be noted that a life cycle of the first task may further include deletion of the first task, and details are not described herein.

For example, that the first node determines resource information of the first task may also be understood as that the first node determines a resource configuration of the first task, or the first node manages a resource of the first task. The resource information of the first task includes any one or more of the following: computing power of the first task, an algorithm of the first task, data of the first task, or a connection of the first task. Usually, the computing power is a computing capability, and the computing power of the first task may be a value of computing power utilized for executing the first task. The algorithm is an algorithm model, for example, a single-point AI model, a joint AI model, model reconfiguration, segmentation point reconfiguration of an AI model, or AI model compression, that needs to be used when the first task is executed. The data of the first task may include a data security configuration of the first task, a data compression manner configuration of the first task, a data collection manner configuration of the first task, and the like. The connection of the first task may include establishment of a dedicated bearer of the first task, a dedicated protocol stack of the first task, a quality of service (quality of service, QoS) mechanism of the first task, and the like.

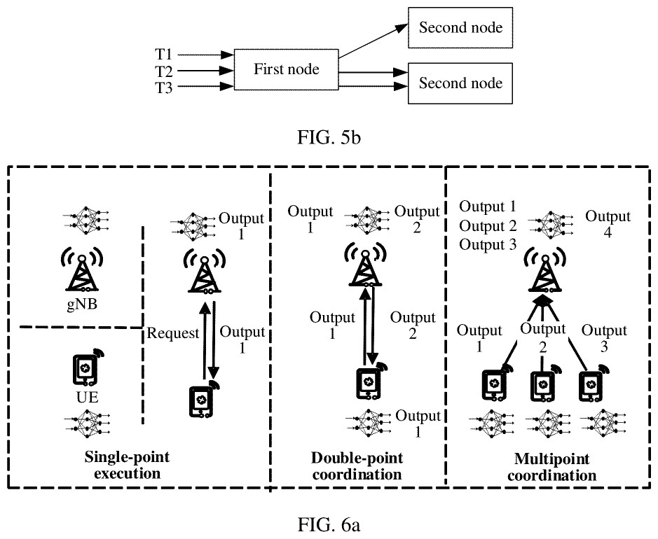

For example, the allocation information of the first task includes any one or more of the following: allocation of an execution node of the first task, allocation of an execution type of the execution node of the first task, and resource allocation of the execution node of the first task. The decomposition information of the first task includes any one or more of the following: a quantity of tasks obtained by decomposing the first task, computing power decomposition of the first task, and the like. A difference between allocation of the first task and decomposition of the first task lies in that the allocation of the first task is mainly allocation of a related resource of the first task, for example, allocation of the execution node of the first task, allocation of the execution type of the execution node of the first task, and allocation of a resource of the execution node of the first task. The decomposition of the first task is mainly decomposition of the first task itself, or decomposition of computing power of the first task. For example, the decomposition of the first task may include a quantity of tasks obtained by decomposing the first task and/or decomposition of the computing power of the first task. As shown in FIG. 5a, identification information of the first task is T1. The first node decomposes the first task into T1_1 and T1_2, and the first node allocates T1_1 to an upper second node shown in FIG. 5a, and allocates T1_2 to a lower second node shown in FIG. 5a. Still as shown in FIG. 5b, the first node obtains three first tasks, and identification information is respectively T1, T2, and T3. The first node allocates T1 to an upper second node shown in FIG. 5b, and allocates T2 and T3 to a lower second node (namely, the execution node) shown in FIG. 5b. It may be understood that the allocation of the first task in this embodiment of this application may also be understood as mapping of the first task, for example, mapping the first task to the second node, or mapping a subtask of the first task to a plurality of second nodes, or the like. One or more second tasks are obtained by decomposing the first task, to enable a plurality of second nodes to compute the second tasks in parallel, so that all computing works of the first task can be completed in short time. This can effectively use an advantage of distributed parallel computation, and shorten completion time of an entire task.

In a second possible implementation, that a first node determines a first task includes the following step: The first node determines at least two second tasks of the first task, where the at least two second tasks correspond to at least two second nodes, and execution types of the at least two second nodes are coordinated execution, or execution types of the at least two second nodes are single-point execution.

For example, a quantity of second tasks is the same as a quantity of second nodes. For another example, a quantity of second tasks is greater than a quantity of second nodes. In other words, one second task or a plurality of second tasks may be allocated to one second node. For another example, a quantity of second tasks is less than a quantity of second nodes. In this case, the second task may be re-decomposed, and then the second node executes the re-decomposed second task.

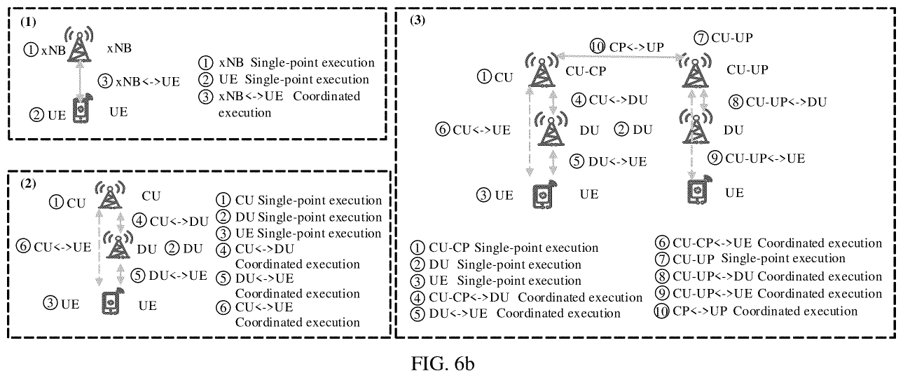

For example, the single-point execution may also be referred to as single-side execution. For example, the second node independently executes the second task. From a perspective of a task, it may also be understood as that the second task is a single-side task. For example, the first node decomposes the first task into one or more second tasks, the one or more second tasks are respectively executed by corresponding second nodes, and each of the second nodes independently executes the second task. For example, a single-side task may be independently executed on a UE side, or may be independently executed on a gNB, a CU, a DU, a CU-CP, a CU-UP, or the like. An execution type of an adaptive modulation and coding (AMC) algorithm shown in FIG. 6a may be single-point execution. If execution of the AMC algorithm is triggered by UE, and then the execution is performed by a gNB, an obtained execution result is shown in an output 1 in FIG. 6a (which may also be understood as that the UE is a task anchor, and the gNB is a task execution point). It may be understood that a network shown in FIG. 6a may be understood as a neural network that includes two input layers, four hidden layers, and three output layers. It may be understood that the descriptions of the network shown in FIG. 6a are also applicable to another accompanying drawing shown in embodiments of this application.

For example, the coordinated execution may be understood as that the second task needs to be executed by two or more second nodes in a coordinated manner. From a perspective of a task, it may also be understood as that the second task is a coordinated multipoint task (where the first task may also be referred to as a coordinated task). The coordinated execution includes coordinated two-point execution, coordinated three-point execution, and the like, which are not listed one by one herein. For example, a task that needs to be coordinately executed by a plurality of second nodes may include any one or more of coordinated computing (which may also be referred to as collaborative computing), coordinated inference, coordinated training, or coordinated sensing. The coordinated two-point in FIG. 6a may include a non-uniform constellation diagram, for example, modulation and demodulation, which is performed by the gNB and the UE in coordination. For example, the UE sends the output 1 to the gNB after obtaining the output 1, and then the gNB obtains an output 2 based on the output 1. Optionally, the gNB may or may not send the output 2 to the UE after obtaining the output 2. For another example, multipoint coordination may include multiple-input multiple-output (MIMO) and coordinated multipoint transmission (CoMP). The multipoint coordination shown in FIG. 6a is shown by using MIMO as an example. When the multipoint coordination is COMP, the multipoint coordination may be performed by a plurality of gNBs, and then outputs of the plurality of gNBs are sent to the UE. It may be understood that a quantity of gNBs and a quantity of UEs shown in FIG. 6a are not limited in this embodiment of this application. The MIMO, CoMP, or non-uniform constellation diagram shown above may be understood as using AI to resolve a network problem, to be specific, using AI for network optimization (AI4NET).

For a network for AI (NET4AI) (to be specific, an AI task is processed by using a network) scenario, where for example, a 5G network is used as an example, for different RAN architectures (for example, a gNB, a CU-DU separation architecture, and a CU-CP and CU-UP separation architecture), the second node may include any one or more of UE, a gNB, a CU, a DU, a CU-CP, or a CU-UP. Therefore, according to different execution types of the second node, a plurality of types of the following manners may exist:
1. Both the UE and the gNB may perform single-point execution. Alternatively, as shown in (1) in FIG. 6b, a coordinated type between the UE and the gNB is two-point coordination (that is, the UE and the gNB coordinate to execute the second task).
2. The CU, the DU, and the UE separately execute the second task in a single-point manner. Alternatively, as shown in (2) in FIG. 6b, the UE and the CU coordinate to execute the second task, the UE and the DU coordinate to execute the second task, or the CU and the DU coordinate to execute the second task.
3. The CU, the DU, the UE, the CU-CP, the CU-UP and the gNB separately perform the second task in a single-point manner. Alternatively, as shown in (3) in FIG. 6b, the CU-CP and the DU coordinate to execute the second task, the DU and the UE coordinate to execute the second task, the CU-CP and the UE coordinate to execute the second task, the CU-UP and the DU coordinate to execute the second task, the CU-UP and the UE coordinate to execute the second task, and the CU-CP and the CU-UP coordinate to execute the second task.

It may be understood that the foregoing coordinated execution is shown by using coordinated two-point execution as an example, and descriptions of coordinated three-point execution or coordinated four-point execution are not listed one by one herein. The coordinated execution shown in embodiments of this application may also be understood as joint execution, collaborative execution, or the like. This is not limited in embodiments of this application.

It should be noted that network elements in a core network may also coordinately execute the second task, or network elements in a core network and network elements in an access network may also coordinately execute the second task. Examples are not described one by one herein.

In a third possible implementation, that a first node determines a first task includes the following steps: The first node receives a trigger message from a trigger node, where the trigger message is used to trigger the first node to process the first task; and the first node determines the first task based on the trigger message. For example, the trigger message may include indication information of a task allocated to the first node. The indication information may enable the first node to learn of a task (for example, including the first task) allocated by the trigger node to the first node. It may be understood that the trigger node may trigger one or more first tasks. A quantity of first tasks is not limited in this embodiment of this application. For example, the trigger node includes a network artificial intelligence management and orchestration (NAMO) network element (which may also be referred to as a NAMO device, a NAMO device, or the like) or an operation and maintenance (OAM) network element. For another example, the trigger node includes any one or more of UE, a gNB, a CU, a DU, a CU-CP, a CU-UP, a RAN TA, an AMF, a UPF, an SMF, or a CN TA. Certainly, alternatively, the first node may independently determine that the first task needs to be processed. For another example, for the NET4AI scenario, the trigger node may be a third-party application, to meet a third-party specification by using a task resource or the like in a network. Optionally, the first node may send capability information of the first node to the trigger node, where the capability information of the first node indicates a capability of the first node to process an AI task. For example, the capability information of the first node may be a capability of the first node, or may be a sum of capabilities of the first node and an execution node managed and controlled by the first node. It may be understood that the capabilities shown herein may include resource capabilities related to an AI task, for example, a computing capability and an algorithm capability, which are not listed one by one herein. Optionally, the capability information of the first node may include a capability of each execution node managed by the first node, or may include a sum of capabilities of execution nodes. This is not limited in this embodiment of this application.
302: The first node sends a first message, where the first message includes identification information of a second task and/or configuration information of the second task, the second task is a subtask of the first task, the second task is executed by the second node, and the second node is one of nodes configured to execute the first task.

The first node may decompose the first task to obtain at least one second task, and then allocate the at least one second task to at least one second node. In other words, the first node may both decompose the first task and allocate at least one second task obtained through decomposition to an execution node. For example, the first node may decompose the first task based on any one or more of computing power, an algorithm, data, or a connection. Optionally, when the first node decomposes the first task to obtain one second task, it indicates that the second task is the first task. In other words, the first node may alternatively not decompose the first task, for example, directly allocate the first task to the second node and/or a forwarding node. Optionally, the first node may further separately allocate at least two first tasks to one second node or at least two second nodes. That is, when receiving two or more tasks, the first node may alternatively not allocate the tasks, but directly decompose the tasks to corresponding second nodes. Optionally, the first node may decompose the first task to obtain two or more second tasks. The first message includes the identification information of the second task, so that the second node can learn which task is to be executed by the second node. Optionally, the first message may further include identification information of the first task, and the identification information of the first task is included, so that the second node can learn that the second task is obtained by decomposing the first task. The first message includes the configuration information of the second task, so that the second node can execute the second task based on the configuration information of the second task. For example, the configuration information of the second task may include any one or more of the following: configuration of any one or more of computing power, an algorithm, data, or a connection of the second task: allocation of an execution node: resource allocation of the execution node: a decomposition status of the first task: or the like. It may be understood that the execution node of the second task shown herein is the second node. Optionally, the first message may include a task allocation status of a corresponding second node, or include a task allocation status of each second node. In other words, the first node may send the first message in a multicast (or broadcast) manner, or may send the first message in a unicast manner.

In a possible implementation, the first node may send the first message to the second node. Correspondingly, the second node receives the first message.

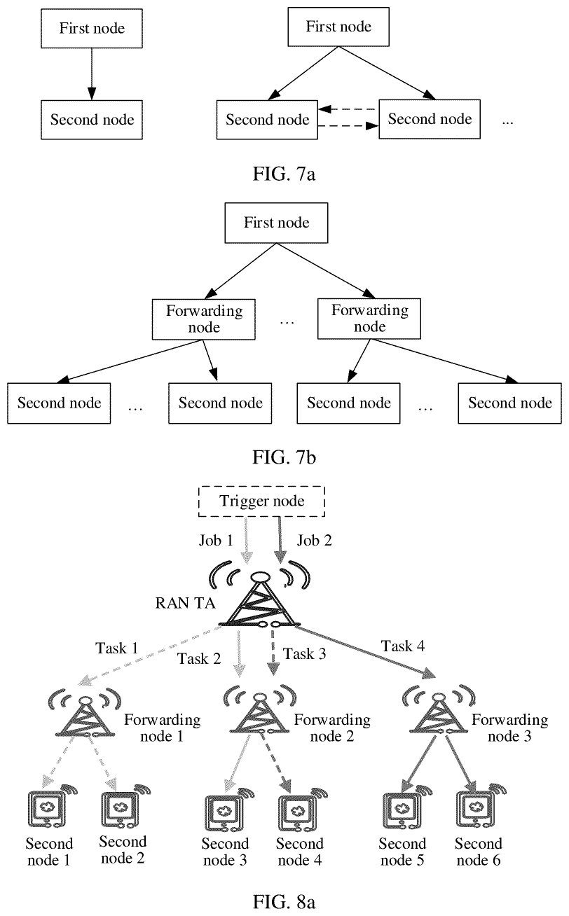

As shown in FIG. 7a, a first node may send a first message to a second node. For example, if the first node itself does not have strong computing power, the first node may not participate in task execution, but is responsible for further decomposing the task to an execution node (namely, a second node) managed by the first node. For another example, the second node cannot decompose and/or allocate the task. For another example, the second node cannot perform secondary decomposition and/or secondary allocation on the task. The secondary decomposition and/or secondary allocation shown herein is described relative to a forwarding node shown below. For example, UE may be understood as an execution node that has an execution function.

For a figure at a left side of FIG. 7a, the first node obtains one second task through decomposition, and the first node sends the first message to one second node. For a figure at a right side of FIG. 7a, the first node obtains a plurality of second tasks through decomposition (where the second node is omitted and represented by an ellipsis in FIG. 7a), and the first node may separately send the first message to each of the plurality of second nodes. For example, each first message may include identification information of a second task allocated to a corresponding second node and/or configuration information of the second task. For example, the configuration information of the second task may include any one or more of computing power, an algorithm, data, or a connection of the second task. It may be understood that, for specific descriptions of the identification information and the configuration information, refer to the foregoing description. Details are not described herein. A dashed line between second nodes shown in FIG. 7a may be understood as that execution types of at least two second nodes are coordinated execution. It may be understood that when the first node cannot directly communicate with the second node, the first node may send the first message to the second node by using another node, and the another node may be configured to forward the first message. That is, the first node and the second node may interact with each other by using another node (that is, transparent forwarding).

It should be noted that, the first node may determine, based on some constraint conditions, the second node that executes the first task. For example, the first node may determine the second node based on conditions such as a network element type and/or an area. It may be understood that the descriptions of the constraint conditions are also applicable to the first node and the forwarding node, and the forwarding node and the second node that are shown below.

In another possible implementation, the first node may send the first message to the second node by using the forwarding node. Correspondingly, the second node receives the first message.

In this embodiment of this application, the forwarding node may be configured to implement a step performed by the first node, and may also be configured to implement a step performed by the second node. For another example, the forwarding node may have both a task execution function and a task managing and controlling function. For another example, the forwarding node may be configured to forward a message, or may be configured to perform secondary decomposition and/or allocation on a task, or the like. For example, the forwarding node receives the first message, and obtains the second task that needs to be executed by the forwarding node. However, because the forwarding node cannot complete the second task, the forwarding node may perform secondary decomposition on the second task to obtain a subtask of the second task, to allocate the subtask of the second task to a corresponding second node. That is, the forwarding node may re-encapsulate the first message received by the forwarding node, to obtain the encapsulated first message, and send the encapsulated first message to the second node. For example, the encapsulated first message may include one or more of identification information of a subtask of the second task, identification information of the second task, or configuration information of the subtask of the second task. It may be understood that a cause why the forwarding node cannot complete the second task may include that the forwarding node cannot complete the second task on time, that computing power of the forwarding node is insufficient to complete the second task, or the like. A cause why the forwarding node cannot complete the second task is not limited in this embodiment of this application. For example, the first node may be a CN TA, the forwarding node may be a RAN TA, and the second node may include a gNB, a CU, a DU, a CU-CP, a CU-UP, UE, or the like. For another example, the first node may be a DU, the forwarding node may be a CU, and the second node may include UE. For another example, the first node may be a CN TA, the forwarding node may be a RAN, and the second node may be UE, a gNB, a CU, a DU, or the like. Herein, the second node is merely an example. For another example, the first node is a CN TA, and the forwarding node may also be a CN TA (a CN TA different from the first node). For another example, the first node is a RAN TA, and the forwarding node may also be a RAN TA (a RAN TA different from the first node).

It should be noted that, if a message sent by the first node to the forwarding node and a message sent by the forwarding node to the second node are referred to as different messages, that the first node sends the first message to the second node by using the forwarding node may also be understood as the following: The first node sends the first message to the forwarding node, where the first message includes the identification information and/or the configuration information of the second task. Because the forwarding node cannot complete the second task on time, the forwarding node possibly decomposes the second task, and then obtains a subtask of the second task. For example, the forwarding node sends a third message to the second node, where the third message includes identification information and/or configuration information of the subtask of the second task. Certainly, the forwarding node may alternatively not decompose the second task, but directly allocate the second task to the second node.

As shown in FIG. 7b, a first node may separately send a first message to one or more forwarding nodes, and at least one of the one or more forwarding nodes may send a re-encapsulated first message to a second node (that is, parsing and forwarding). It may be understood that the forwarding node shown in this embodiment of this application may alternatively be understood as a first-level task execution node relative to the first node, and the forwarding node may alternatively be understood as a second-level task anchor relative to the second node. In other words, the first node may be referred to as a first-level task anchor, and the second node may be referred to as a second-level task execution node. In addition, a logical function of the first-level task anchor includes resource management of the second-level task anchor, and task decomposition and allocation to the second-level task anchor. Execution nodes below the second-level task anchor are not directly managed by the first-level task anchor. After receiving tasks obtained through decomposition performed by the first-level task anchor, the second-level task anchor may further perform task decomposition (only an example), manage resources of all execution nodes of the second-level task anchor or a next-level task anchor, and the like. If a network architecture shown in FIG. 7a is understood as a two-level network architecture, and a network architecture shown in FIG. 7b is understood as a three-level network architecture, the network architecture shown in embodiments of this application may alternatively be of four levels, five levels, or the like. In other words, the network architecture shown in embodiments of this application is of N levels, where N is an integer greater than or equal to 2, for example, N=2, N=3, N=4, or N=5.
303: The second node executes the second task.

For example, the second node may execute the second task based on the configuration information of the second task. If the configuration information of the second task includes computing power of the second task, the second node may execute the second task based on a value of the computing power of the second task. For another example, if the configuration information of the second task includes an algorithm of the second task, the second node may execute the second task based on the algorithm of the second task. Details are not listed one by one herein.

In a possible implementation, the method shown in FIG. 3 may further include the following:

The second node sends capability information to the first node. Correspondingly, the first node receives the capability information from the second node, where the capability information indicates a capability of the second node to execute a task. That a first node determines a first task includes the following: The first node determines the first task based on the capability information. In this embodiment of this application, capability negotiation may be performed between the first node and the second node, that is, the first node may allocate the second task based on the capability of the second node, thereby improving efficiency of allocating the second task by the first node. Optionally, the forwarding node may alternatively send capability information to the first node, so that the first node determines the first task based on the capability information of the forwarding node. It should be noted that the forwarding node may alternatively send capability information to the first node, so that the first node allocates a task, a resource, or the like to the forwarding node based on the capability information of the forwarding node. For example, the capability information sent by the forwarding node to the first node may indicate a capability of the forwarding node, or may indicate a sum of capabilities of the forwarding node and an execution node managed and controlled by the forwarding node. It may be understood that the capabilities shown herein may include resource capabilities related to an AI task, for example, a computing capability and an algorithm capability, which are not listed one by one herein. Optionally, the capability information of the forwarding node may include a capability of each execution node managed and controlled by the forwarding node, or may include a sum of capabilities of execution nodes. This is not limited in this embodiment of this application.

In a possible implementation, the method shown in FIG. 3 may further include the following:

The first node sends a resource configuration request to the second node, where the resource configuration request is used to request to configure a resource for the second node. Correspondingly, after receiving the resource configuration request, the second node may accept the resource configuration request, or may reject the resource configuration request. For example, after the first node determines a life cycle of the first task, the first node may send the resource configuration request to the second node, where the resource configuration request is used to configure computing power, an algorithm, data, a connection, or the like for the second node. Optionally, the first node may alternatively send the resource configuration request to the forwarding node. It should be noted that the first node may alternatively send the resource configuration request to the forwarding node.

In a possible implementation, the method shown in FIG. 3 may further include the following:

The second node sends a second message to the first node, where the second message indicates an execution result of the second task. Correspondingly, the first node receives the second message. For example, the execution result may include any one or more of an inference result, a computation result, a sensing result, a training result, or a learning result. Optionally, the second message may be an execution result of executing the second task by one second node. Optionally, the second message may be execution results of respectively executing the second task by a plurality of second nodes. To be specific, the execution results of the second task may be reported to the first node by second nodes respectively corresponding to the execution results, or may be reported to the first node by a specified second node. The specified second node may be specified by the first node, specified by the trigger node, specified in a protocol, or the like. This is not limited in this embodiment of this application. Alternatively, the execution results of the second task may be reported to another specified node, and the another specified node may apply the execution results, or may collectively report the execution results to the first node. Optionally, the second node may alternatively send the second message to the forwarding node. Correspondingly, the forwarding node receives the second message. Then, the forwarding node sends the second message to the first node. For example, the forwarding node may combine execution results of all second nodes, and then send the combined execution result to the first node. The first node combines execution results reported by all forwarding nodes, to obtain the execution result of the first task. It may be understood that descriptions of the forwarding node and the second message are also applicable below.

It should be noted that, the second node may alternatively not send the second message to the first node. For example, the second node may locally apply the execution result.

In a possible implementation, the method shown in FIG. 3 may further include the following:

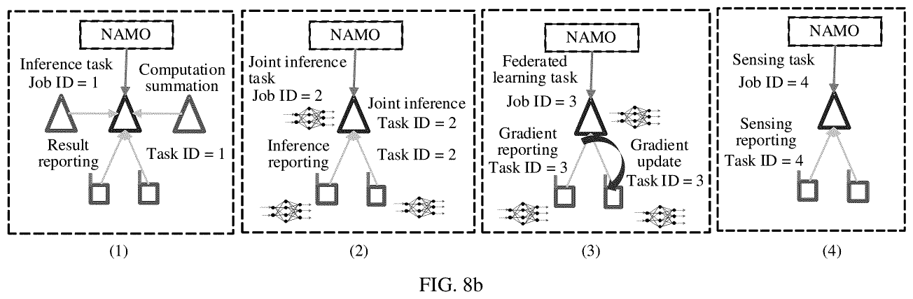

The first node receives at least two second messages, and combines execution results of the first task based on the at least two second messages, where the second message indicates the execution result of the second task. In this embodiment of this application, the first node may combine the execution results corresponding to all the second nodes, to obtain the execution result of the first task. It may be understood that combination of execution results of the first task shown in this embodiment of this application corresponds to decomposition of the first task. For example, as shown in FIG. 8a, a RAN TA needs to process two first tasks. For example, the two first tasks are respectively represented by a job 1 and a job 2. For a same job, identifiers (IDs) of second tasks (for example, represented by task) executed by different execution nodes may be the same or may be different. For example, the job 1 is decomposed into a task 1 and a task 2, and the job 2 is decomposed into a task 3 and a task 4. As shown in FIG. 8a, the RAN TA allocates the task 1 to a forwarding node 1, allocates the task 2 and the task 3 to a forwarding node 2, and allocates the task 4 to a node 3. The forwarding node 1 further performs secondary decomposition on the task 1, and allocates the decomposed second task to a second node 1 and a second node 2. For specific descriptions of the forwarding node 2 and the forwarding node 3, refer to the descriptions of the forwarding node 1. Details are not described herein. It may be understood that FIG. 8a is described by using an example in which the trigger node triggers the RAN TA to manage and control the job 1 and the job 2. The RAN TA may alternatively autonomously trigger the RAN TA to manage and control the job 1 and the job 2. It can be learned from the description in FIG. 8a that the RAN TA may decompose one job into one or more tasks, and then allocate the one or more tasks to the forwarding node. That is, the RAN TA needs to perform a job decomposition operation and an operation of mapping a job ID to a task ID(s) (which may also be understood as allocation of a task ID to an execution node). Correspondingly, the forwarding node 1 may send, to the RAN TA, an execution result of the task 1 obtained by the forwarding node 1, the forwarding node 2 may send, to the RAN TA, execution results of the task 2 and the task 3 that are obtained by the forwarding node 2, and the forwarding node 3 sends, to the RAN TA, an execution result of the task 4 obtained by the forwarding node 3. Finally, the RAN TA may combine the task 1 and the task 2, to obtain an execution result of the job 1, and combine the task 3 and the task 4, to obtain an execution result of the job 2. It may be understood that FIG. 8a is described by using an example in which IDs of different tasks are different. For example, IDs of the task 1 and the task 4 may also be the same. In this case, the RAN TA may distinguish between execution results of different tasks based on IDs of forwarding nodes. Because the task 2 and the task 3 are executed by the forwarding node 2, the task 2 and the task 3 need to be distinguished by using different identifiers. The RAN TA may distinguish between execution results of a specific task by using IDs of tasks and/or IDs of execution nodes. It should be noted that, different IDs may be used to distinguish between different tasks, and different configuration information of tasks may also be used to distinguish between the tasks. This is not limited in this embodiment of this application.

For example, as shown in (1) in FIG. 8b, a NAMO triggers a RAN TA to process a task whose job ID is 1, and the RAN TA decomposes the task into two tasks, where the two tasks have a same ID (because the two tasks are to be allocated to different UEs for execution, the IDs of the two tasks may be the same), and the two tasks are respectively allocated to different UEs. It may be understood that (1) in FIG. 8b may be understood as a computing task. To be specific, when allocating a task, the RAN TA may allocate the task to any UE (for example, two UEs shown in FIG. 8b) that meets a computing power design specification. After obtaining a computing result, the UE may report an execution result whose task ID is 1 to the RAN TA. As shown in (2) in FIG. 8b, a task whose job ID is 2 may be a joint inference task. Because the task is a joint inference task, a RAN TA needs to allocate a task whose task ID is 2 to specified UE, UE that meets a preset condition, or the like. The UE needs to report an inference result to the RAN TA after obtaining the inference result. The RAN TA needs to perform joint inference after obtaining the inference result of the UE. As shown in (3) in FIG. 8b, a task whose job ID is 3 may be a federated learning task. A RAN TA separately allocates a task whose task ID is 3 to two UEs. The UEs need to report gradient results to the RAN TA after obtaining the gradient results. The RAN TA combines the gradient results, and then allocates an obtained result to the two UEs again, to obtain final gradient information after a specific optimization objective is achieved. As shown in (4) in FIG. 8b, a task whose job ID is 4 is a sensing task. A RAN TA decomposes the sensing task, and separately allocates a task whose task ID is 4 to two UEs, so that the two UEs report sensing results to the RAN TA after obtaining the sensing results. The RAN TA may perform processing such as summation (or combination) and compression based on the sensing results.

It should be noted that the first node may alternatively not decompose or allocate the first task. For example, the first node also has a computing function. If a computing capability of the first node can ensure that the task is completed within a specified QoS target, the first node may perform computing by itself, and does not need to deliver a task (for example, the first task) to the second node for execution. It should be noted that both the first node and the second node shown in this embodiment of this application may be nodes configured to implement steps or functions of a task anchor. For example, both the first node and the second node may be CN TAs or RAN TAs. Alternatively, the first node is a CN TA, and the second node is a RAN TA: or the first node is a RAN TA, and the second node is a CN TA.

It may be understood that the method shown in FIG. 3 may include one or more of the foregoing implementations, and any combination thereof falls within the protection scope of embodiments of this application.

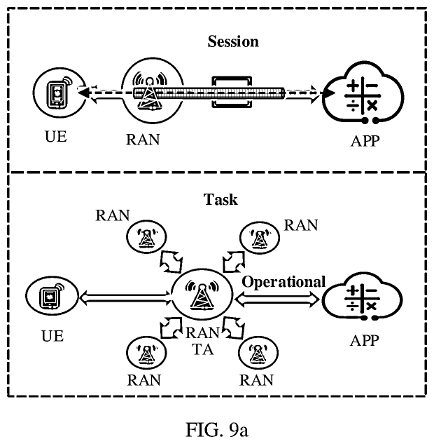

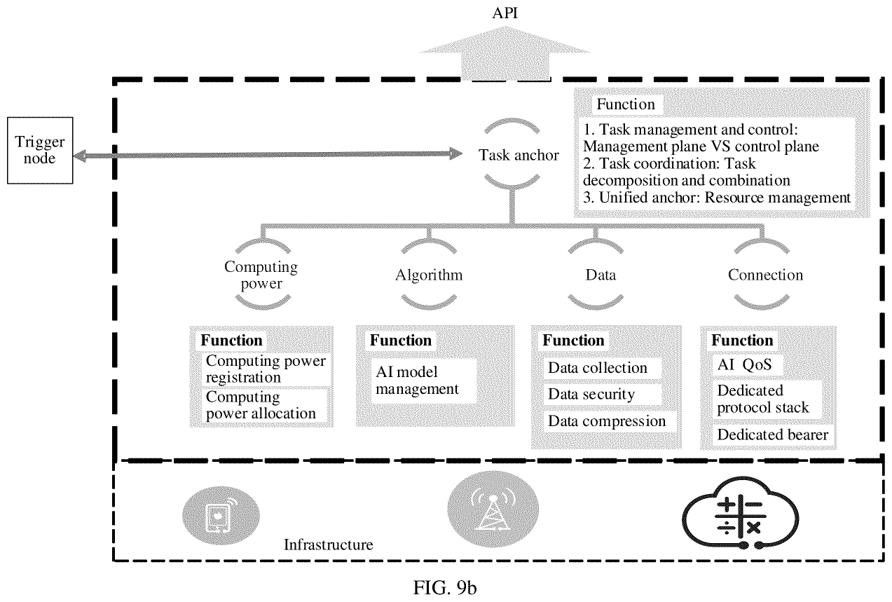

As shown in FIG. 9a, a 5G network communication system includes session management (session management), and life cycle management is performed on an end-to-end (E2E) tunnel (tunnel) established around a UE communication target. This corresponds to connection resource management. However, in this embodiment of this application, more resources (such as computing power, an algorithm, data, and a connection) are added in AI use, and an objective is also changed from user session management to AI task management. Therefore, a RAN TA and/or a CN TA in this embodiment of this application is used to perform corresponding life cycle management on a task. An APP shown in FIG. 9a may be understood as a third-party application, and the third-party application may provide a service for a user.

To further describe a difference between a task anchor (for example, the RAN TA and/or the CN TA) and a task execution point (for example, a RAN and/or a CN) in embodiments of this application, the following provides descriptions from a perspective of functions.

In this embodiment of this application, the RAN TA and/or the CN TA may manage a related resource (for example, computing power, an algorithm, data, a connection, sensing, and scheduling) at a granularity of a computing task, an AI task, a sensing task, or the like, to implement life cycle management and control (for example, by using management signaling and/or control signaling) on a related task. In addition, an AI for network optimization (AI4NET) function may be further implemented, and/or a network for AI (NET4AI) function may be further implemented; and the function is opened to the outside.

For example, as shown in FIG. 9b, a RAN TA and/or a CN TA may implement any one or more of the following functions:
1. Task decomposition and combination: 2. Selection of a participating node of a task (for example, a specified node or random selection), task allocation (which may also be referred to as task mapping), and configuration information of an allocated task: 3. Task life cycle management, including addition of a configuration parameter of a computing task, an AI task, or a sensing task, modification of a configuration parameter of an existing computing task, AI task, or sensing task, deletion of an existing computing task, AI task, or sensing task, querying of a status or a progress of an existing computing task, AI task, or sensing task, reporting of a result of an existing computing task, AI task, or sensing task, task anchor migration and a corresponding procedure, and execution node migration and a corresponding procedure; and 4. Task resource management, including the following: obtaining a latest resource status (for example, computing power, an algorithm, data, a connection, and sensing) of each execution node (for example, for a RAN TA, the execution node is a forwarding node or a second node; and for a forwarding node, the execution node is a second node), scheduling and monitoring, at a granularity of a specific task, a resource, for example, computing power, an algorithm, data, or a connection related to the task, to ensure smooth execution of the task, controlling and managing a resource of a node that has a computing capability, and centrally managing and controlling a sensing resource. For example, managing a task-related resource at a granularity of a task includes the following: managing a computing power resource, including: computing power capability negotiation, computing power registration or reporting, computing power requesting, and the like: managing an algorithm resource, including: algorithm capability negotiation and AI model management (single-point AI model configuration, joint AI model configuration, model reconfiguration, AI model segmentation point reconfiguration, and AI model compression): managing a data resource, including: data capability negotiation, data collection, data security configuration, data compression manner configuration, and the like; and managing a connection resource, including: establishment of a dedicated bearer for a task, a dedicated protocol stack for a task, and QoS mechanism definition for a task. It may be understood that for a relationship between a trigger node and a task anchor in FIG. 9b, refer to the foregoing description. Details are not described herein. Optionally, the RAN TA and/or the CN TA (that is, the task anchor is used as an example in FIG. 9b) may further include an application programming interface (API). The API may be used for opening to the outside, so that the RAN TA and/or the CN TA may provide a service for a third party. Optionally, the RAN TA and/or the CN TA may further include an interface for interacting with a NAMO and/or an OAM, a resource management interface, and the like. The RAN TA and/or the CN TA further includes an interface for interacting with a RAN and/or a CN. Optionally, the RAN TA may further include an interface for interacting with another RAN TA and/or another CN TA. Optionally, the CN TA may further include an interface for interacting with another CN TA and/or another RAN TA.

For example, the RAN and/or the CN may implement any one or more of the following functions:
1. Resource capability reporting, status reporting (for example, reporting of a latest status of computing power, load, memory, power, and the like), and exception information reporting: 2. Task resource managing and controlling, for example, accepting/rejecting a resource request of the task anchor (for example, task life cycle management); and 3. Task execution, execution result reporting, and the like. The RAN and/or the CN may include an interface for interacting with the RAN TA and/or the CN TA. Optionally, the RAN and/or the CN may further include an interface for interacting with another coordinating node, and the like.

In this embodiment of this application, the first core network device and/or the first access network device manages and controls an AI task. In this way, related management/control of the AI task is standardized, thereby effectively improving AI task management efficiency. In addition, the first core network device and/or the first access network device may more flexibly allocate a task by decomposing and/or allocating the first task, so that the second node can execute a task that matches a capability of the second node. This further improves AI task management efficiency, and further improves task execution efficiency of the second node.

According to the method provided in this embodiment of this application, a related processing procedure of the AI task is standardized. Compared with a method for managing and controlling a task by using program code, a case in which program code needs to be updated in real time is effectively avoided, thereby effectively improving AI task management efficiency.

The following describes the task processing method provided in this embodiment of this application by using an example in which the first node includes a CN TA and a RAN TA. For example, both the CN TA and the RAN TA may implement the method shown in FIG. 3. For example, the first node may manage and control the second node in a manner (including a manner of function definition) of control signaling (for example, through a control plane or through a user plane) to transfer a message. The message is transferred in the manner of control signaling, to achieve an objective of task allocation or task management and controlling. In this implementation, not only real-time performance (for example, at a millisecond-level) is high, but also an entire operator network can be covered. The foregoing manner of function definition may be understood as the following: defining enabling and disabling of various types of computing power, defining enabling and disabling of various algorithms, defining enabling and disabling of various data, defining enabling and disabling of various connections, or the like.

The following describes in detail an interface and a protocol stack between different network elements in embodiments of this application.

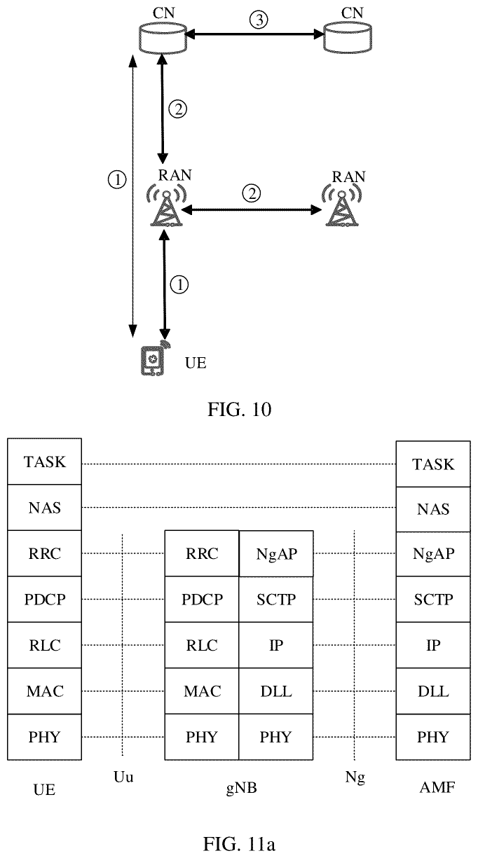

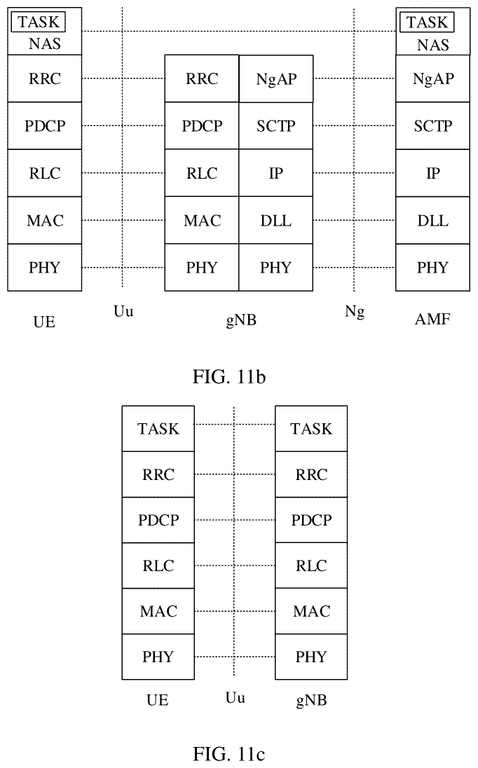

FIG. 10 is a schematic diagram of interaction between different network elements according to an embodiment of this application. As shown in FIG. 10, \textcircled{1} represents interaction between an access network and UE, and interaction between a core network and the UE: \textcircled{2} represents interaction between the core network and the access network, and represents interaction between access networks; and \textcircled{3} represents interaction between core networks. The following uses three cases shown in FIG. 10 as an example for detailed description. It may be understood that FIG. 10 does not specifically distinguish between a RAN TA and a RAN and between a CN TA and a CN. Therefore, FIG. 10 should not be understood as a limitation on embodiments of this application. A function (TASK) layer in a protocol stack shown below represents a protocol layer that can process an AI-related task and that is improved in this embodiment of this application. In addition, a name of a task shown below is merely an example, and the name is not limited in this embodiment of this application.

### Case 1

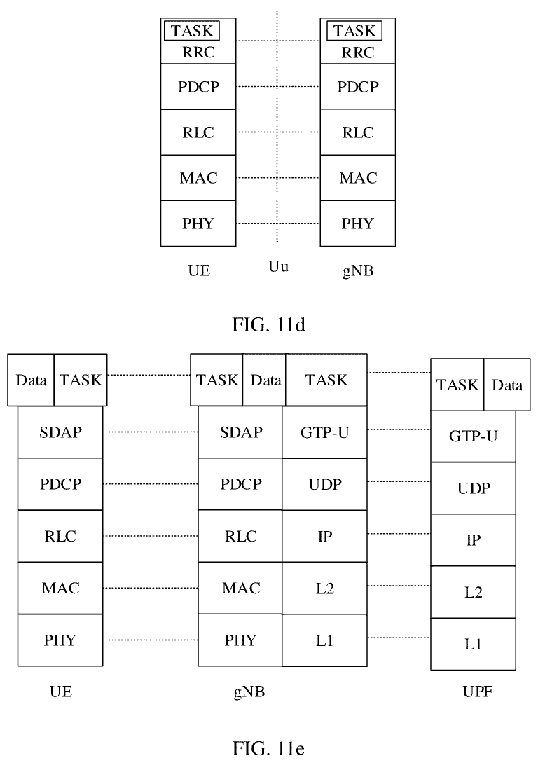

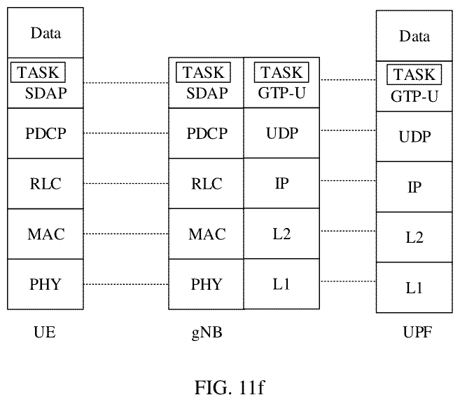

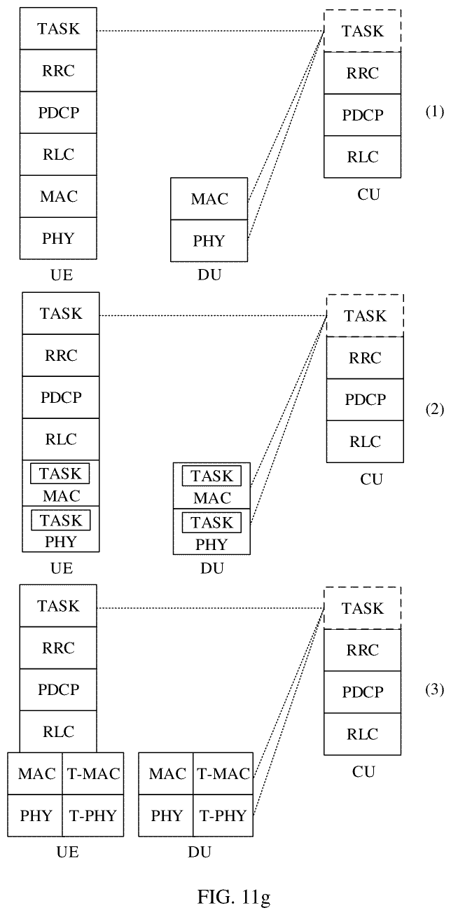

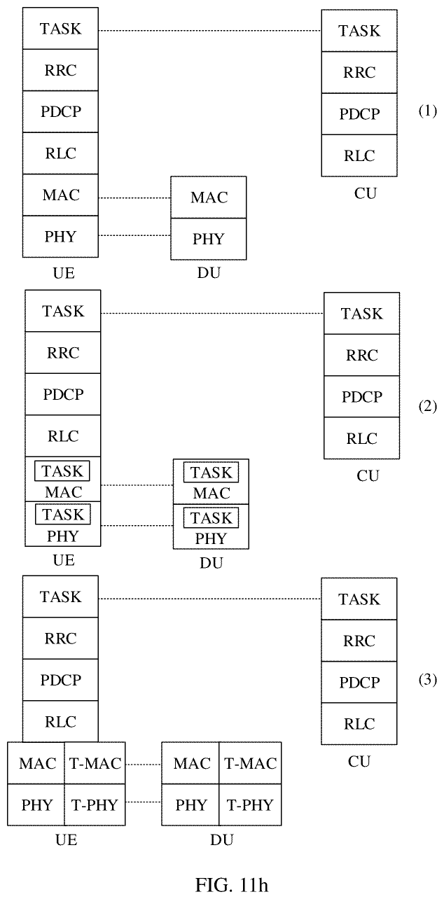

Optionally, as shown in FIG. 11a, a protocol layer (TASK shown in FIG. 11a) for interaction between a first core network device and UE is located above NAS. To be specific, to transmit task-related signaling (including a first message) between the first core network device and the UE, in this embodiment of this application, a TASK protocol layer is added in a protocol stack of the UE, and a TASK protocol layer is added in a protocol stack of the first core network device. The TASK protocol layer independently runs on the NAS.

Optionally, as shown in FIG. 11b, a protocol layer for interaction between a first core network device and UE is located in a NAS. To be specific, the first core network device may send a first message through NAS signaling. The NAS signaling can bear a message (for example, including the first message) related to an AI task. That is, a function of the NAS is enhanced so that the NAS can be used to transmit signaling related to the AI task. Therefore, related signaling (for example, task allocation signaling or task management signalling) is transmitted between the first core network device and the UE by using a NAS protocol layer. When signaling is transmitted by using the NAS protocol layer, the signaling is transparent and invisible to an access network device. For example, during downlink transmission, the access network device transparently transmits related signaling to the UE. For another example, during uplink transmission, the access network device transparently transmits related signaling to the first core network device.

It may be understood that the TASK protocol layer shown in FIG. 11a may independently run above the NAS, and therefore logic of various protocol layers is clear. In FIG. 11b, the function of the NAS is enhanced to ensure that a quantity of layers of the protocol stack remains unchanged. Therefore, signaling overheads remain unchanged. This description is also applicable to the following.

Optionally, as shown in FIG. 11c, a protocol layer (TASK shown in FIG. 11c) for interaction between a first access network device and UE is located above RRC layer. Optionally, for a protocol stack of the UE, the TASK and the NAS may be located above the RRC layer in parallel. For a protocol stack of the first access network device, the TASK protocol is located above the RRC layer. Alternatively, a first core network device may send a first message to the first access network device by using an NgAP protocol layer, and the first access network device sends the first message to the UE by using the TASK protocol layer. It may be understood that when a function of the first access network device is a forwarding function, a message between the first core network device and the UE may alternatively be forwarded by using a first access network device or the like. In addition, when the first access network device further needs to perform secondary decomposition on a task, the first core network device needs to interact with the UE by using the first access network device. In this case, a protocol stack for interaction between the first access network device and the first core network device is located above the NgAP, or is located in the NgAP.

Optionally, as shown in FIG. 11d, a protocol layer for interaction between a first access network device and UE is located in RRC layer. Alternatively, a first core network device sends a first message to the first access network device by using a NgAP protocol, and the first access network device sends the first message to the UE by using an RRC protocol layer (refer to FIG. 11c). In this implementation, a TASK protocol layer is not added, but an RRC function is enhanced, so that the RRC can be used to transmit control signaling related to an AI task. During downlink transmission, a RAN parses signaling (including the first message) such as task configuration of a CN, and then bears a first message through RRC signaling. During uplink transmission, UE sends a second message to the RAN through RRC signaling, and the RAN sends the second message to the CN through an Ng interface.

Optionally, as shown in FIG. 11e, a first access network device sends a first message to UE by using a TASK protocol that is located above SDAP layer and that is in a user plane protocol stack. For a protocol stack of the UE, the TASK protocol layer and a data protocol layer may be located above the SDAP layer in parallel. For a protocol stack of the first access network device, the TASK protocol is located above the SDAP layer. As shown in FIG. 11e, optionally, a protocol layer for interaction between the first access network device and a UPF may be located above a general packet radio system (GPRS) tunneling protocol-user plane (GTUP). Optionally, a protocol layer for interaction between the first access network device and the UE may alternatively be located above SDAP layer and below data (for a user plane of the UE). Optionally, a protocol layer for interaction between the first access network device and the UPF may alternatively be located above the GTP-U layer and below the data (for a user plane of the UPF).

Optionally, as shown in FIG. 11f, a first access network device sends a first message to UE by using an SDAP protocol layer. In this implementation, a TASK protocol layer is not added, but an SDAP function is enhanced, so that the SDAP can be used to transmit signaling related to an AI task. Optionally, a protocol layer for interaction between the first access network device and a UPF may be located above a general packet radio system (GPRS) tunneling protocol-user plane (GTP-U). It may be understood that, for description of FIG. 11f, refer to FIG. 11e. Details are not described herein.

It may be understood that, in the embodiments shown in FIG. 11e and FIG. 11f, compared with FIG. 11a to FIG. 11d, the first message is not borne by using a control plane, but is borne by using a user plane, for example, a data radio bearer. FIG. 11a to FIG. 11f are shown by using a gNB as an example. When the first access network device is a CU, a CU-CP, a CU-UP, or the like, as the protocol stack of the first access network device changes, the protocol stack for interaction between the first core network device and the first access network device may also change. Details are not described herein. Similarly, the first core network device is shown by using an AMF and a UPF as an example. This embodiment of this application is also applicable to another core network device. The descriptions of the change of the protocol stack are also applicable to the following.

Optionally, a protocol layer for interaction between the CU and the UE may be located above RRC layer, or may be located in the RRC layer. For example, refer to FIG. 11c and FIG. 11d. For ease of description, the following describes interaction between UE and a DU by using an example in which a protocol for interaction between the CU and the UE is located above RRC layer.

Optionally, as shown in (1) in FIG. 11g, UE interacts with a DU by using a CU. It may be understood that, TASK in the CU shown in FIG. 11g is represented by a dashed line because if the CU performs transparent forwarding, a protocol stack of the CU may not include the TASK; or if the CU performs parsing and forwarding, a protocol stack of the CU may include the TASK. As shown in (2) in FIG. 11g, when UE and a DU need to coordinate in a PHY layer (for example, a radio transmission technology (radio transmission technology, RTT) algorithm) and/or a MAC layer (for example, a radio resource management (radio resource management, RMM) algorithm), functions of the MAC and the PHY may be separately enhanced. For example, the MAC and the PHY may separately have a function of processing an AI task. As shown in (3) in FIG. 11g, a T-MAC protocol layer and a T-PHY protocol layer may be separately added, and the added T-MAC protocol layer and the added T-PHY protocol layer may be located below RLC. For example, a MAC protocol layer and the T-MAC protocol layer may be located below the RLC in parallel, a PHY protocol layer is located below the MAC protocol layer, and the T-PHY protocol layer is located below the T-MAC protocol layer.

Optionally, as shown in (1) in FIG. 11h, UE and a DU may alternatively directly interact with each other. As shown in (2) in FIG. 11h, functions of a MAC and a PHY may be separately enhanced. For example, the MAC and the PHY may separately have a function of processing an AI task. As shown in (3) in FIG. 11h, a T-MAC protocol layer and a T-PHY protocol layer may be separately added, and the added T-MAC protocol layer and the added T-PHY protocol layer may be located below RLC. In this implementation, a case in which direct interaction between the UE and the DU needs to be forwarded by using the CU can be effectively reduced, thereby effectively reducing a delay of direct interaction between the UE and the DU.

### Case 2

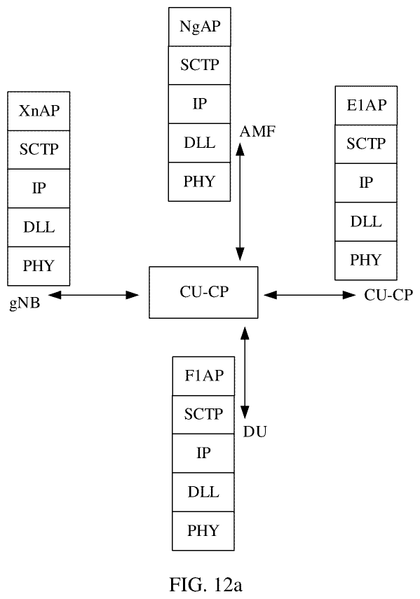

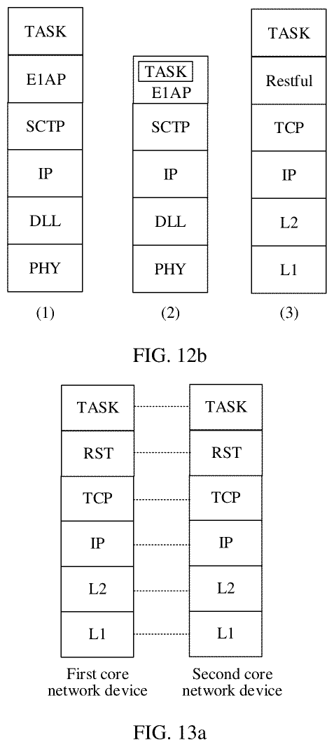

Optionally, as shown in FIG. 12a, an interface between a gNB and a CU-CP is an Xn interface, corresponding to an XnAP protocol layer: an interface between the CU-CP and a DU is an F1 interface, corresponding to an F1AP protocol layer: an interface between the CU-CP and a CU-UP is an E1 interface, corresponding to an E1 AP protocol layer; and an interface between the CU-CP and an AMF is an Ng interface, corresponding to an NgAP protocol layer. It may be understood that for descriptions of an interface and a protocol layer between different network elements, refer to FIG. 2d. Details are not described herein. For ease of description, the following uses interaction between a CU-CP and a CU-UP as an example to describe a protocol layer related to an AI task in embodiments of this application.

Optionally, as shown in (1) in FIG. 12b, a protocol layer for interaction between a CU-CP and a CU-UP is located above E1AP layer. In other words, a TASK protocol layer is added in a protocol stack of the CU-CP. Optionally, as shown in (2) in FIG. 12b, a protocol layer for interaction between a CU-CP and a CU-UP is located in E1AP layer. In other words, an E1AP function is enhanced so that the E1AP can be used to process an AI task. Optionally, as shown in (3) in FIG. 12b, a protocol layer for interaction between a CU-CP and a CU-UP is located above representational state transfer (RST) (which may also be referred to as Restful). In other words, a design is performed based on a service-based architecture (SBA), to add a TASK protocol layer above the RST protocol layer. Optionally, the added TASK protocol layer may alternatively be used to implement the E1AP function. The Task is designed based on a service-based interface. This is more flexible. It may be understood that specific descriptions of a layer 1 (L1), a layer 2 (L2), an IP, and a transmission control protocol (TCP) that are included in a protocol stack of the SBA are not described in detail.

It may be understood that for descriptions of a protocol layer for interaction between gNBs, a protocol layer for interaction between a CU and a DU, and a protocol layer for interaction between a gNB and an AMF, refer to related descriptions in FIG. 12b. Details are not described herein. For example, the protocol layer for interaction between the gNBs may be located above an XnAP protocol layer, may be located in the XnAP protocol layer, or may be located above the RST protocol layer.

### Case 3

It may be understood that, for a protocol layer for interaction between a first core network device and UE, refer to Case 1. Details are not described herein.

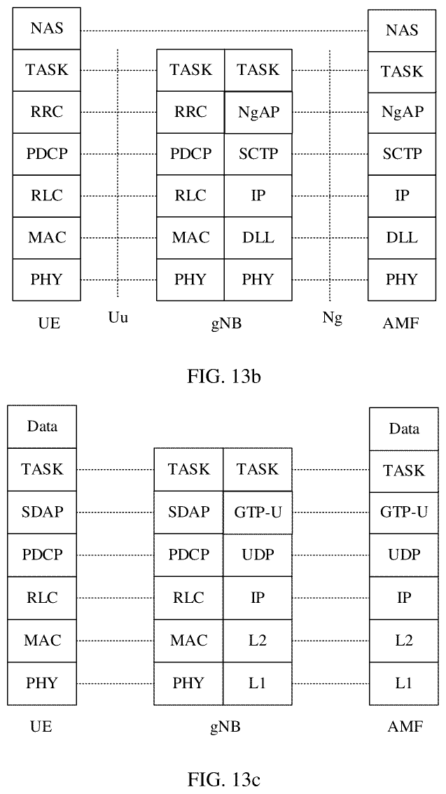

Optionally, as shown in FIG. 13a, a protocol layer for interaction between the first core network device and a second core network device may be located above RST. Optionally, a protocol layer for interaction between the first core network device and the second core network device may alternatively be located in the RST layer (not shown in FIG. 13a).

Optionally, as shown in FIG. 13b, a protocol layer for interaction between a first core network device and a first access network device is located above NgAP, and a protocol layer for interaction between the first access network device and the UE is located above RRC layer. It may be understood that the first core network device may perform, by using the first access network device, task allocation and the like on another access network device managed and controlled by the first access network device. It may be understood that a protocol stack shown in FIG. 13b is merely an example. For the protocol layer for interaction between the first core network device and the first access network device and the protocol layer for interaction between the first access network device and the UE, reference may be further made to FIG. 11b. Details are not listed one by one herein.

Optionally, as shown in FIG. 13c, a protocol layer for interaction between a first core network device and a first access network device is located above GTP-U layer, and a protocol stack for interaction between the first access network device and UE is located above SDAP layer. It may be understood that a protocol stack shown in FIG. 13c is merely an example. For the protocol layer for interaction between the first core network device and the first access network device and the protocol layer for interaction between the first access network device and the UE, refer to FIG. 11e or FIG. 11f. Details are not listed one by one herein.

It should be noted that interaction between the first core network device and the UE and interaction between the first access network device and the UE in this embodiment of this application are also applicable to interaction between a second core network device and the UE and interaction between a second access network device and the UE. Interaction between the gNB and the AMF is also applicable to interaction between other network elements of a similar protocol stack, and interaction between the gNB and the UE is also applicable to interaction between other network elements of a similar protocol stack. Details are not listed one by one in this embodiment of this application. The protocol stack between the network elements shown above is merely an example. Any implementation that can be combined with another implementation or two other implementations or the like in different implementations shown above falls within the protection scope of this application.

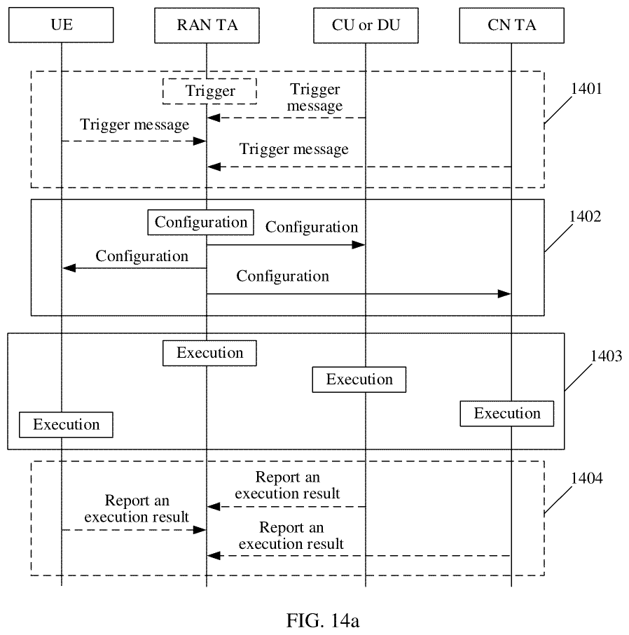

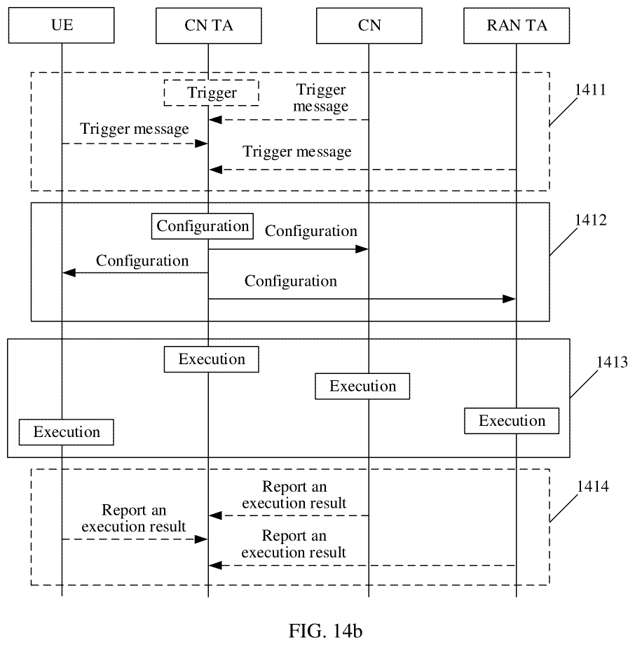

FIG. 14a is a schematic flowchart of a task processing method according to an embodiment of this application. As shown in FIG. 14a, the method includes the following steps.
1401: A RAN TA obtains a trigger message, where the trigger message is used to trigger the RAN TA to process a first task. Step 1401 shown in FIG. 14a shows triggering or a trigger message as an example.

Optionally, the RAN TA may trigger the RAN TA to process the first task. In this case, the RAN TA may not generate the trigger message, but directly perform step 1402. Optionally, the RAN TA may receive a trigger message sent by a trigger node. For a description of the trigger node, refer to the foregoing description of step 301. Details are not described herein.
1402: The RAN TA determines the first task, and sends a first message. For example, the RAN TA determines allocation, decomposition, and the like of the first task, and configures the first task for a corresponding execution node. It may be understood that the configuration in step 1402 shown in FIG. 14a may be understood as that the RAN TA sends the first message to a corresponding node, to configure a task. The descriptions of the configuration in step 1402 are also applicable to step 1412 shown below.

Optionally, the RAN TA decomposes the first task to obtain a second task, where an execution node of the second task may be the RAN TA. Optionally, the execution node of the second task may alternatively be another access network device, for example, a gNB, a CU, a DU, a CU-CP, a CU-UP, or a RAN TA. Optionally, the execution node of the second task may be UE. Optionally, the execution node of the second task may be a CN TA or the like. It may be understood that for descriptions of the execution node, refer to the foregoing descriptions of the second node and/or the forwarding node. Details are not described herein. It may be understood that the trigger node in step 1401 may be the same as or different from the second node in step 1402. This is not limited in this embodiment of this application.
1403: The execution node executes the second task. Step 1403 shown in FIG. 14a shows execution as an example.
1404: The execution node reports an execution result (for example, sends a second message).

Optionally, execution nodes may respectively report respective execution results of the execution nodes to the RAN TA. Optionally, the execution nodes may further report the execution results together to another node, and then the another node reports the execution results together to the RAN TA. For example, the another node may be indicated to the execution nodes by using the first message. For another example, the trigger node specifies the another node. For another example, the another node may be preconfigured, for example, preconfigured in a protocol, preconfigured by an OAM, or the like. Optionally, the RAN TA may send a combined execution result to the trigger node, or the RAN TA may directly apply the execution result locally, or the like. This is not limited in this embodiment of this application. It may be understood that after obtaining the execution result, the execution node may alternatively not report the execution result, but directly apply the execution result locally. This is not limited in this embodiment of this application.

In this embodiment of this application, the RAN TA decomposes and/or allocates the AI task, and the like, so that an interface between different network elements in an access network can be effectively used.

FIG. 14b is a schematic flowchart of another task processing method according to an embodiment of this application. As shown in FIG. 14b, the method includes the following steps.
1411: A CN TA obtains a trigger message, where the trigger message is used to trigger the CN TA to process a first task.
1412: The CN TA determines the first task, and sends a first message.

It may be understood that, during domain-based autonomy, one CN TA may alternatively simultaneously manage one or more RAN TAs. For example, one CN TA may separately allocate tasks to the one or more RAN TAs. Optionally, the one or more RAN TAs may perform secondary decomposition on the task, and the like.
1413: The execution node executes a second task.
1414: The execution node reports an execution result (for example, sends a second message).

It may be understood that for specific descriptions of FIG. 14b, refer to FIG. 14a. Details are not described herein.

In this embodiment of this application, the CN TA decomposes and/or allocates the AI task, and the like. Because the CN TA may manage and control one or more access networks, the CN TA may manage and control a relatively large quantity of execution nodes and/or forwarding nodes.

The foregoing mainly describes the task processing method by using an example in which the first node includes the first core network device and/or the first access network device. The following describes the method provided in embodiments of this application by using an example in which the first node includes a NAMO and/or an OAM.

The NAMO shown in embodiments of this application may be understood as a central AI service flow orchestrator, and may be configured to orchestrate and decompose a service, and the like. The NAMO may alternatively be understood as a task dispatcher (which may also be referred to as a pod manager, a task allocator, or the like). The second node may be understood as a task execution node (for example, may also be referred to as a pod, a task executor, or the like). That is, each second node delivers a task by using a dispatcher of the task, and executes the task, to implement distributed parallel computing. However, in this embodiment of this application, when allocating a task, the NAMO may send a first message to a CN TA and/or a RAN TA, and then the CN TA and/or the RAN TA is used as a second-level management node to manage a network element and UE in a domain of the CN TA and/or the RAN TA. In other words, a network element and UE in each domain of the CN TA and/or the RAN TA are invisible to the NAMO. That is, the NAMO may be understood as the first node shown above, the RAN TA and/or the CN TA may be understood as the forwarding node shown above, and the network element in the domain corresponding to the RAN TA (which may also be understood as another network element other than the RAN TA in the RAN) and/or the network element in the domain corresponding to the CN TA (which may also be understood as another network element other than the CN TA in the CN) may be understood as the second node shown above. In addition, the NAMO may be understood as a first-level task anchor, and the RAN TA and/or the CN TA may be understood as a second-level task anchor or a first-level task execution point. If a relationship between a pod and a pod manager is used for description, the NAMO serves as a first-level pod manager to control a RAN TA and/or a CN TA that serves as a pod; and the RAN TA and/or the CN TA serve/serves as a second-level pod manager to control another network element or UE in a CN/RAN that serve/serves as a pod, performs secondary decomposition on a task allocated by the NAMO, and delivers the task to all pod nodes managed by the NAMO, and the pod node executes the task delivered by the RAN TA and/or the CN TA, and reports the task to the second-level pod manager for combination. It may be understood that, for specific descriptions of the CN TA and/or the RAN TA, refer to the foregoing description. Details are not described herein. For example, the RAN TA may be a gNB or a CU in a 5G system, a network element that is newly defined in a 6G system and that has a base station function, or the like. For another example, the CN TA may be an AMF in a 5G system, one newly defined network element in a 6G system, or the like. According to embodiments of this application, the RAN TA and/or the CN TA may more flexibly and dynamically select an execution node based on a service target and QoS. It may be understood that the descriptions of the NAMO herein are also applicable to the OAM. Details are not described in the following.

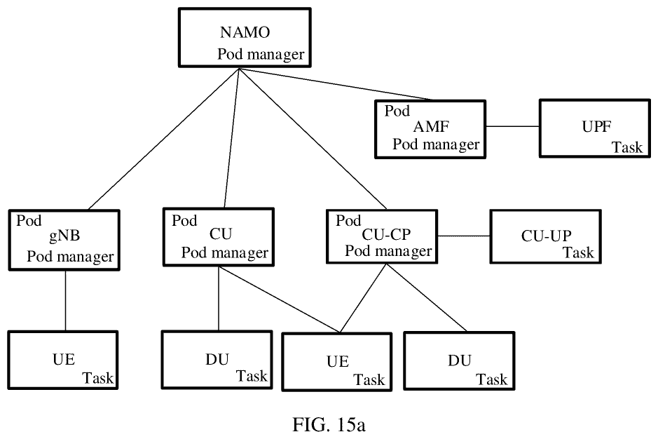

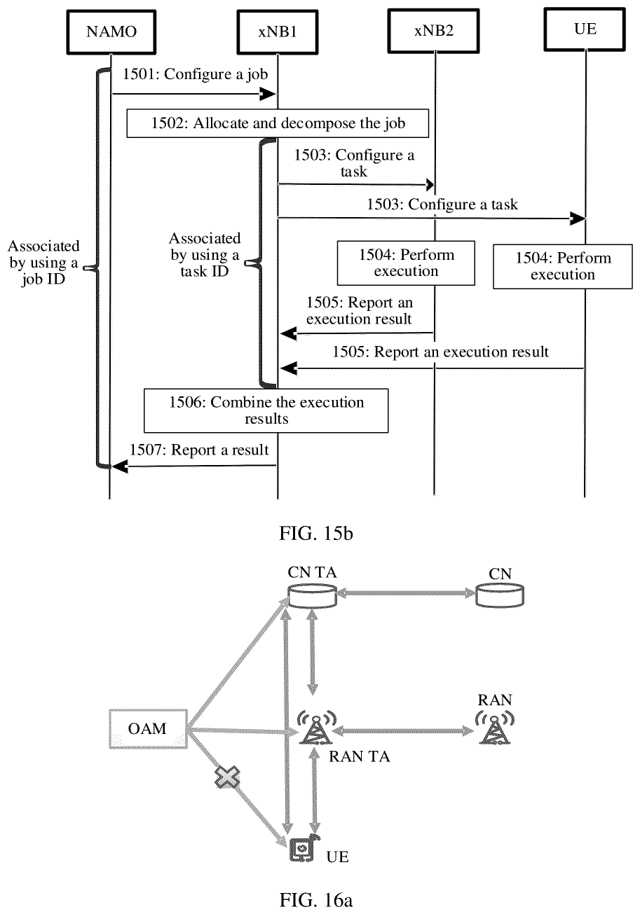

For example, as shown in FIG. 15a, a NAMO, as a pod manager, can manage and control a network element that serves as a pod. In other words, the NAMO may allocate a task to any one or more of an AMF, a gNB, a CU, a CU-CP, or the like. Then, the AMF that serves as a pod manager performs secondary decomposition on a task received from the NAMO, and then allocates a task (task is used as an example in FIG. 15a) to a network element, for example, a UPF, in a domain of the AMF, the gNB that serves as a pod manager allocates a task to a network element, for example, UE, that is managed by the gNB, the CU that serves as a pod manager allocates a task to a network element, for example, a DU and/or UE, that is managed by the gNB, or the CU-CP that serves as a pod manager allocates a task to a network element, for example, UE, a DU, or a CU-UP, that is managed by the CU-CP. It may be understood that the three-level network shown in FIG. 15a is merely an example, and a network architecture in which the NAMO is used as the first node may alternatively be of four levels, five levels, or the like. It may be understood that FIG. 15a is merely an example and should not be understood as a limitation on embodiments of this application.

The following uses an example shown in FIG. 15b to describe the task processing method provided in embodiments of this application. It may be understood that, in FIG. 15b, xNB1 may be understood as a RAN TA, and xNB2 may be understood as a RAN that is not a TA or may be understood as another RAN TA or the like. In addition, FIG. 15b shows only one xNB2 and one UE. During specific implementation, the xNB1 may allocate a task to more xNBs and more UEs based on a resource status of the task, or the xNB1 may allocate a task to one or more UEs or the like. This is not limited in this embodiment of this application.

As shown in FIG. 15b, the task processing method includes the following steps.
1501: A NAMO determines a first task (as shown in FIG. 15b, a job is used as an example), and configures the first task for the xNB1. It may be understood that step 1501 shown in FIG. 15b is shown by using a job configuration as an example, and should not be construed as a limitation on this embodiment of this application.
1502: The xNB1 allocates and decomposes the job.
1503: The xNB1 configures the task for the xNB2 and the UE.

For example, the xNB1 decomposes the job to obtain one or more subtasks (represented by, for example, task). As shown in FIG. 15b, the xNB1 may decompose the job into two tasks, and allocate the two tasks to the xNB2 and the UE.
1504: The xNB2 executes the task allocated by the xNB1, and the UE executes the task allocated by the xNB2.
1505: The xNB2 and the UE report execution results.
1506: The xNB1 combines the execution results.

It may be understood that IDs of the two tasks obtained through decomposition by the xNB1 may be the same or may be different. When the IDs of the two tasks are the same, the xNB1 may distinguish between the two tasks based on IDs of task execution nodes.
1507: The xNB1 reports an execution result obtained through combination to the NAMO.

It may be understood that step 1507 shown in FIG. 15b is shown by using result reporting as an example, and should not be construed as a limitation on this embodiment of this application.

It may be understood that for specific descriptions of FIG. 15b, refer to the foregoing related descriptions of FIG. 3. Details are not described one by one herein.

It may be understood that FIG. 15b is described by using an example in which the subtask obtained after the NAMO decomposes the first task based on a resource of the task is still the first task. However, after the NAMO decomposes the first task, two or more subtasks may be obtained, and may be represented by, for example, task. In this case, the xNB1 may obtain the subtasks after decomposing the task. In this case, step 1502 to step 1506 in FIG. 15b need to be associated by using a subtask ID. It may be understood that, for a task received by the RAN TA and/or the CN TA from the NAMO, a specific device may be specified for execution or a specific type of device may be specified (for example, a specific gNB is specified for execution or specific UE is specified for execution): for a collaborative task, a plurality of devices may alternatively be specified for execution, or the like.

In this embodiment of this application, the first task may be any one of a collaborative computing task, a collaborative inference task, a collaborative training task, a collaborative sensing task, or the like. A type of the first task is not limited in this embodiment of this application. For example, sensing, as a new application of 5G and 6G, gives a base station more functions and values. For example, the base station may sense information such as an environment, a channel, and a building around the base station through terahertz imaging. Alternatively, the base station may have a function similar to a radar, and can track information (such as a location, an angle, a distance, and a moving speed) of a moving object/target in real time through radar wave reflection. However, because a sensing capability of a single base station is limited, sometimes sensing information of a larger area needs to be obtained. In this case, a task needs to be decomposed to more base stations for sensing. In addition, because a geographical location of the base station is fixed, if a large quantity of UEs can also participate in the task for joint sensing, sensing information can be enriched and sensing accuracy can be improved. For the collaborative sensing task, the xNB1 may allocate the job to more xNBs and more UEs. For the collaborative training task, when receiving execution results of the xNB2 and the UE, the xNB1 may update a model based on the two execution results, to report a final result to the NAMO. For different tasks, steps in which the xNB1 combines execution results may be different, and are not listed one by one in this embodiment of this application.

Compared with a case in which the NAMO manages and controls all network elements (which may also be understood as that the NAMO manages all nodes, which belongs to a flat management manner), in this embodiment of this application, the NAMO manages first-level pods (which belongs to a vertical management manner), and these first-level pods serve as pod managers and manage pod nodes (task nodes shown in FIG. 15a) of the first-level pods. Therefore, these first-level pods need to serve as the pod managers to have management functions such as secondary decomposition and combination of tasks.

From a method procedure shown in FIG. 15b, after receiving the task allocated by the NAMO, the CN TA and/or the RAN TA further decomposes the task into subtasks, and allocates corresponding subtask IDs. From a perspective of the NAMO, task allocation and combination are associated by a job ID. The CN TA and/or the RAN TA performs secondary decomposition and combination of tasks by using subtask IDs/task IDs. (The CN TA and/or the RAN TA performs secondary decomposition of tasks, allocates subtask IDs/task IDs, and delivers corresponding subtasks to other nodes. Each node reports a subtask result and a corresponding subtask ID after completing computing.)

In this embodiment of this application, a multi-level management manner (as shown in FIG. 15a) is used, so that a case in which tasks are all allocated to network elements by using the NAMO is effectively improved, thereby reducing load of the NAMO. A one-level or multi-level pod manager function is added in a CN domain and/or a RAN domain, to implement level-by-level task decomposition and/or allocation, and support diversified heterogeneous computing capabilities (for example, some nodes have strong computing capabilities, but some nodes have weak computing capabilities). In addition, heterogeneous computing power and secondary decomposition are transparent to the NAMO. This effectively reduces management complexity of the NAMO.

Usually, an OAM can directly manage the CN and/or the RAN (that is, a network element in the CN and/or a network element in the RAN) through an interface-north (Itf-N) or an interface-south (Itf-S). Therefore, in this embodiment of this application, the interface may alternatively be reused, so that the OAM can implement the steps or functions performed by the first node shown above. To be specific, the OAM shown in this embodiment of this application may implement a task management and orchestration function similar to those of the NAMO, and use network elements and interfaces in 3GPP to form a standardized network, to support life cycle management and execution of a task, and the like. In other words, in this embodiment of this application, the OAM needs to manage, schedule, and allocate resources such as computing power, an algorithm, data, a connection, and sensing, to ensure smooth execution of a task (for example, meeting a task QoS target). In addition, the OAM includes a management interface, where the management interface may support task management and/or configuration, and the like.

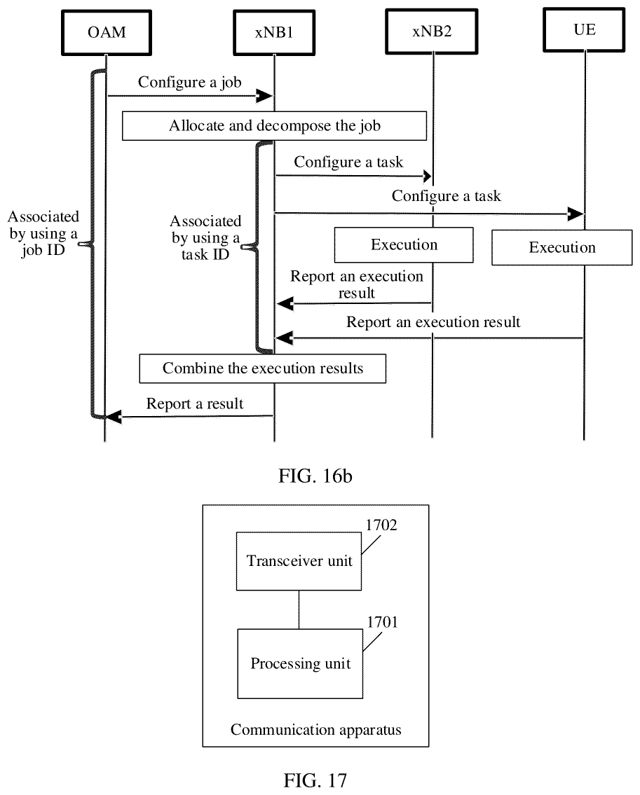

As shown in FIG. 16a, when allocating a task, an OAM may send a first message to a CN TA and/or a RAN TA, and then the CN TA and/or the RAN TA serves as a second-level management node to manage a network element and UE in a domain of the CN TA and/or the RAN TA, that is, the network element and the UE in each domain of the CN TA and/or the RAN TA are invisible to the OAM. For details about the OAM, refer to the NAMO.

For example, as shown in FIG. 16b, a task processing method includes the following steps: An OAM determines a first task, and configures the first task for xNB1: the xNB1 allocates and decomposes a job: the xNB1 configures tasks for xNB2 and UE respectively: the xNB2 executes the task allocated by the xNB1, and the UE executes the task allocated by the xNB2; and the xNB2 and the UE respectively report execution results. The xNB1 combines the execution results. It may be understood that for specific descriptions of FIG. 16b, refer to FIG. 15b. Details are not described herein.

In this embodiment of this application, the management plane OAM network element can implement the steps or functions performed by the first node shown above, and can further schedule a plurality of resources (such as computing power, an algorithm, data, a connection, and sensing), orchestrate a service stream, decompose a task, allocate a task, and combine execution results, thereby ensuring smooth execution of an AI task.

A difference between FIG. 15b and FIG. 16b lies in that, in FIG. 15b, the NAMO may send the first message to the CN TA and/or the RAN TA in a code manner (for example, by using executable program code), to configure a task. In addition, the CN TA and/or the RAN TA may deliver a task to another network element in a code manner. In FIG. 16b, that the OAM allocates a task, the RAN TA and/or the CN TA allocates a task, and the like is performed by using a function switch manner. For example, FIG. 16b may be understood as that a task is allocated in a function definition manner, for example, differentiated control is implemented on a function by enabling or disabling a specific function and setting different parameter values of the function. For example, federated learning may be a function, or a neural network may be a function. To be specific, FIG. 15b may be understood as that the method shown in embodiments of this application is implemented from an application layer or an internet technology (IT), but FIG. 16b may be understood as that the method shown in embodiments of this application is implemented from a management plane. In addition, FIG. 14a and FIG. 14b may be understood as that the method shown in embodiments of this application is implemented from a control plane.

It should be noted that the first node shown above may alternatively be UE, or UE that has a specific type of feature, or the like, and the second node may be UE, an access network device, or a core network device. For a description that the first node is the UE, refer to the foregoing description. Details are not described one by one herein.

A communication apparatus provided in an embodiment of this application is described below.

In this application, the communication apparatus is divided into function modules based on the foregoing method embodiments. For example, each function module may be divided to each corresponding function, or two or more functions may be integrated into one processing module. The integrated module may be implemented in a form of hardware, or may be implemented in a form of a software functional module. It should be noted that, in this application, module division is an example, and is merely a logical function division. During actual implementation, another division manner may be used. The following describes in detail communication apparatuses in embodiments of this application with reference to FIG. 17 to FIG. 19.

FIG. 17 is a schematic diagram of a structure of a communication apparatus according to an embodiment of this application. As shown in FIG. 17, the communication apparatus includes a processing unit 1701 and a transceiver unit 1702.

In some embodiments of this application, the communication apparatus may be the first node, a chip in the first node, or the like shown above. To be specific, the communication apparatus may be configured to perform steps, functions, or the like performed by the first node in the foregoing method embodiments.

The processing unit 1701 is configured to determine a first task, where the communication apparatus includes a first core network device and/or a first access network device, and the first task is a task related to artificial intelligence AI.

The transceiver unit 1702 is configured to send a first message, where the first message includes identification information of a second task and/or configuration information of the second task, the second task is a subtask of the first task, the second task is executed by a second node, and the second node is one of determined nodes configured to execute the first task.

In this embodiment of this application, for descriptions of the first task, the first message, the first node, the second node, and the like, refer to the descriptions in the foregoing method embodiments. Details are not described herein.

It may be understood that specific descriptions of the transceiver unit and the processing unit described in this embodiment of this application are merely examples. For specific functions, steps, or the like of the transceiver unit and the processing unit, refer to the foregoing method embodiments. Details are not described herein. For example, the transceiver unit 1702 may be further configured to perform the receiving step and/or the sending step shown in FIG. 14a and/or FIG. 14b, and the processing unit 1701 may be further configured to perform the configuration step shown in FIG. 14a and/or FIG. 14b, and the like. The steps performed by the first node are not listed one by one herein.

FIG. 17 is reused. In some other embodiments of this application, the communication apparatus may be the second node, a chip in the second node, or the like shown above. To be specific, the communication apparatus may be configured to perform steps, functions, or the like performed by the second node in the foregoing method embodiments.

The transceiver unit 1702 is configured to receive a first message from a first node, where the first message includes identification information of a second task and/or configuration information of the second task, the second task is a subtask of the first task, the first task is a task related to artificial intelligence AI, and the first node includes a first core network device and/or a first access network device.

The processing unit 1701 is configured to execute the second task.

In this embodiment of this application, for descriptions of the first task, the first message, the first node, the second node, and the like, refer to the descriptions in the foregoing method embodiments. Details are not described herein.

It may be understood that specific descriptions of the transceiver unit and the processing unit described in this embodiment of this application are merely examples. For specific functions, steps, or the like of the transceiver unit and the processing unit, refer to the foregoing method embodiments. Details are not described herein. For example, the processing unit 1701 may be further configured to perform the execution step shown in FIG. 14a and/or FIG. 14b, and the transceiver unit 1702 may be further configured to perform the receiving step and/or the sending step shown in FIG. 14a and/or FIG. 14b. The steps performed by the second node are not listed one by one herein. It may be understood that for specific descriptions of the transceiver unit and the processing unit, refer to the descriptions of the fifth aspect and/or the sixth aspect and the like.

FIG. 17 is reused. In still other embodiments of this application, the communication apparatus may be the forwarding node, a chip in the forwarding node, or the like shown above. To be specific, the communication apparatus may be configured to perform steps, functions, or the like performed by the forwarding node in the foregoing method embodiments.

For example, the transceiver unit 1702 is configured to receive a first message from a first node.

The processing unit 1701 is configured to decompose and/or allocate a second task based on the first message. It may be understood that the steps performed by the forwarding node are not listed one by one herein.

The foregoing describes the nodes in embodiments of this application, and the following describes possible product forms of the nodes. It should be understood that any product that has the functions of the nodes described in FIG. 17 falls within the protection scope of embodiments of this application. It should be further understood that the following description is merely an example, and a product form of the node in this embodiment of this application is not limited thereto.

In a possible implementation, in the communication apparatus shown in FIG. 17, the processing unit 1701 may be one or more processors; and the transceiver unit 1702 may be a transceiver or the transceiver unit 1702 may be a sending unit and a receiving unit, the sending unit may be a transmitter, the receiving unit may be a receiver, and the sending unit and the receiving unit are integrated into one device, for example, a transceiver. In this embodiment of this application, the processor and the transceiver may be coupled, or the like. A manner of connection between the processor and the transceiver is not limited in this embodiment of this application.

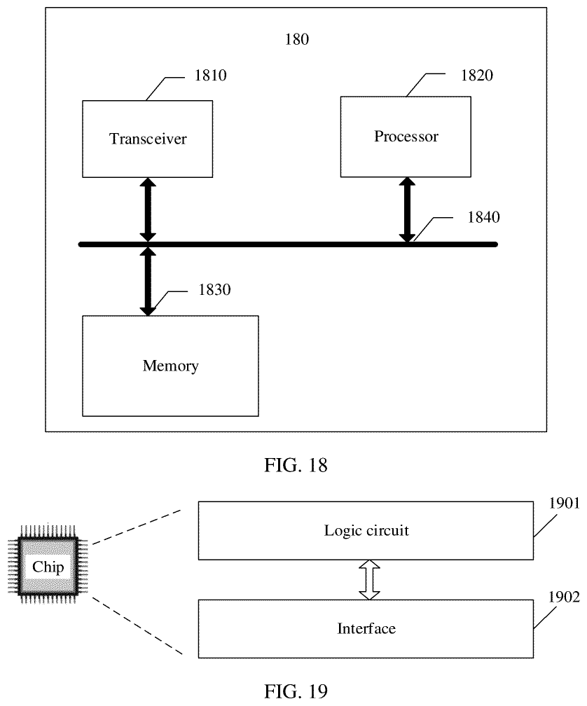

As shown in FIG. 18, a communication apparatus 180 includes one or more processors 1820 and a transceiver 1810.

For example, when the communication apparatus is configured to implement the steps, the methods, or the functions performed by the first node, the processor 1820 is configured to determine a first task, where the communication apparatus includes a first core network device or a first access network device, and the first task is a task related to artificial intelligence AI. The transceiver 1810 is configured to send a first message, where the first message includes identification information of a second task and/or configuration information of the second task, the second task is a subtask of the first task, the second task is executed by a second node, and the second node is one of determined nodes configured to execute the first task.

For example, when the communication apparatus is configured to implement the steps, the methods, or the functions performed by the second node, the transceiver 1810 is configured to receive a first message from a first node, where the first message includes identification information of a second task and/or configuration information of the second task, the second task is a subtask of the first task, the first task is a task related to artificial intelligence AI, and the first node includes a first core network device and/or a first access network device.

For example, when the communication apparatus is configured to implement the steps, the methods, or the functions performed by the forwarding node, the transceiver 1810 is configured to receive a first message, and the processor 1820 is configured to decompose and/or allocate a second task, and the like.

It may be understood that for specific descriptions of the processor and the transceiver, refer to the descriptions of the processing unit and the transceiver unit shown in FIG. 17, or refer to the foregoing method embodiments. Details are not described herein.

In various implementations of the communication apparatus shown in FIG. 18, the transceiver may include a receiver and a transmitter, the receiver is configured to perform a receiving function (or operation), and the transmitter is configured to perform a transmitting function (or operation). In addition, the transceiver is configured to communicate with another device/apparatus through a transmission medium.

Optionally, the communication apparatus 180 may further include one or more memories 1830, configured to store program instructions and/or data. The memory 1830 is coupled to the processor 1820. The coupling in this embodiment of this application may be an indirect coupling or a communication connection between apparatuses, units, or modules in an electrical form, a mechanical form, or another form, and is used for information exchange between the apparatuses, the units, or the modules. The processor 1820 may cooperate with the memory 1830 to perform an operation. The processor 1820 may execute the program instructions stored in the memory 1830. Optionally, at least one of the one or more memories may be included in the processor.

A specific connection medium between the transceiver 1810, the processor 1820, and the memory 1830 is not limited in this embodiment of this application. In this embodiment of this application, the memory 1830, the processor 1820, and the transceiver 1810 are connected by using a bus 1840 in FIG. 18. The bus is represented by using a bold line in FIG. 18. A manner of connection between other components is merely an example for description, and is not limited thereto. The bus may be classified into an address bus, a data bus, a control bus, and the like. For ease of representation, only one bold line is used to represent the bus in FIG. 18, but this does not mean that there is only one bus or only one type of bus.

In this embodiment of this application, the processor may be a general-purpose processor, a digital signal processor, an application-specific integrated circuit, a field programmable gate array or another programmable logic device, a discrete gate or a transistor logic device, a discrete hardware component, or the like. The processor can implement or execute the methods, the steps, and the logical block diagrams disclosed in embodiments of this application. The general-purpose processor may be a microprocessor or any conventional processor or the like. The steps of the methods disclosed in combination with embodiments of this application may be directly implemented by a hardware processor, or may be implemented by using a combination of hardware and software modules in the processor, or the like.

In this embodiment of this application, the memory may include but is not limited to a nonvolatile memory, for example, a hard disk drive (HDD) or a solid-state drive (SSD), a random access memory (RAM), an erasable programmable read-only memory (EPROM), a read-only memory (OM), or a portable read-only memory (CD-ROM). The memory is any storage medium that can be used to carry or store program code in a form of instructions or a data structure and that can be read and/or written by a computer (for example, the communication apparatus shown in this application). However, this application is not limited thereto. The memory in this embodiment of this application may alternatively be a circuit or any other apparatus that can implement a storage function, and is configured to store the program instructions and/or the data.

The processor 1820 is mainly configured to: process a communication protocol and communication data, control an entire communication apparatus, execute a software program, and process data of the software program. The memory 1830 is mainly configured to store the software program and the data. The transceiver 1810 may include a control circuit and an antenna. The control circuit is mainly configured to: perform a conversion between a baseband signal and a radio frequency signal, and process the radio frequency signal. The antenna is mainly configured to send and receive a radio frequency signal in a form of an electromagnetic wave. An input/output apparatus, for example, a touchscreen, a display, or a keyboard, is mainly configured to: receive data input by a user and output data to the user.

For example, after the communication apparatus is powered on, the processor 1820 may read the software program in the memory 1830, interpret and execute instructions of the software program, and process the data of the software program. When the data needs to be sent wirelessly, the processor 1820 performs baseband processing on the to-be-sent data, and outputs a baseband signal to a radio frequency circuit. The radio frequency circuit performs radio frequency processing on the baseband signal, and then sends out the radio frequency signal through the antenna in a form of an electromagnetic wave. When data is sent to the communication apparatus, the radio frequency circuit receives a radio frequency signal through the antenna, converts the radio frequency signal into a baseband signal, and outputs the baseband signal to the processor 1820, and the processor 1820 converts the baseband signal into data, and processes the data.

In another implementation, the radio frequency circuit and the antenna may be disposed independent of the processor that performs baseband processing. For example, in a distributed scenario, the radio frequency circuit and the antenna may be remotely disposed independent of the communication apparatus.

It may be understood that the communication apparatus shown in this embodiment of this application may alternatively include more components than those shown in FIG. 18, or the like. This is not limited in this embodiment of this application. The foregoing methods performed by the processor and the transceiver are merely examples. For specific steps performed by the processor and the transceiver, refer to the methods described above.

In another possible implementation, in the communication apparatus shown in FIG. 17, the processing unit 1701 may be one or more logic circuits, and the transceiver unit 1702 may be an input/output interface, or may be referred to as a communication interface, an interface circuit, an interface, or the like. Alternatively, the transceiver unit 1702 may include a sending unit and a receiving unit. The sending unit may be an output interface, and the receiving unit may be an input interface. The sending unit and the receiving unit are integrated into one unit, for example, an input/output interface. As shown in FIG. 19, the communication apparatus shown in FIG. 19 includes a logic circuit 1901 and an interface 1902. That is, the processing unit 1701 may be implemented by using the logic circuit 1901, and the transceiver unit 1702 may be implemented by using the interface 1902. The logic circuit 1901 may be a chip, a processing circuit, an integrated circuit, a system on chip (SoC), or the like. The interface 1902 may be a communication interface, an input/output interface, a pin, or the like. For example, in FIG. 19, the foregoing communication apparatus is shown by using a chip as an example, and the chip includes a logic circuit 1901 and an interface 1902.

In this embodiment of this application, the logic circuit and the interface may be further coupled to each other. A specific manner of connection between the logical circuit and the interface is not limited in this embodiment of this application.

For example, when the communication apparatus is configured to implement the methods, the functions, or the steps performed by the first node, the logic circuit 1901 is configured to determine a first task, and the interface 1902 is configured to output a first message.

For example, when the communication apparatus is configured to implement the methods, the functions, or the steps performed by the second node, the interface 1902 is configured to input a first message, and the logic circuit 1901 is configured to execute a second task.

For example, when the communication apparatus is configured to implement the methods, the functions, or the steps performed by the forwarding node, the interface 1902 is configured to input a first message, and the logic circuit 1901 is configured to decompose and/or allocate a second task.

It may be understood that the communication apparatus shown in embodiments of this application may implement the method provided in embodiments of this application in a form of hardware, or may implement the method provided in embodiments of this application in a form of software. This is not limited in embodiments of this application.

For specific implementations of the embodiments shown in FIG. 19, refer to the foregoing embodiments. Details are not described herein.

An embodiment of this application further provides a wireless communication system. The wireless communication system includes a second node and a first node. The second node and the first node may be configured to perform the method in any one of the foregoing embodiments. Optionally, the wireless communication system further includes a forwarding node.

In addition, this application further provides a computer program. The computer program is configured to implement the operations and/or the processing performed by the second node in the method provided in this application.

This application further provides a computer program. The computer program is configured to implement the operations and/or the processing performed by the first node in the method provided in this application.

This application further provides a computer-readable storage medium. The computer-readable storage medium stores computer code. When the computer code is run on a computer, the computer is enabled to perform the operations and/or the processing performed by the second node in the method provided in this application.

This application further provides a computer-readable storage medium. The computer-readable storage medium stores computer code. When the computer code is run on a computer, the computer is enabled to perform the operations and/or the processing performed by the first node in the method provided in this application.

This application further provides a computer program product. The computer program product includes computer code or a computer program. When the computer code or the computer program is run on a computer, the operations and/or the processing performed by the second node in the method provided in this application is enabled to be performed.

This application further provides a computer program product. The computer program product includes computer code or a computer program. When the computer code or the computer program is run on a computer, the operations and/or the processing performed by the first node in the method provided in this application is enabled to be performed.

In the several embodiments provided in this application, it should be understood that the disclosed system, apparatus, and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. Some or all of the units may be selected based on actual design specifications to achieve the technical effects of the solutions provided in the embodiments in this application.

In addition, functional units in embodiments of this application may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to the conventional technologies, or all or some of the technical solutions may be implemented in a form of a software product. The software product is stored in a storage medium and includes a plurality of instructions for instructing a computer device (which may be a personal computer, a server, or a network device) to perform all or some of the steps of the methods described in embodiments of this application. The readable storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A task processing method, wherein the method comprises:
determining, by a first node, a first task, wherein the first node comprises a first core network device or a first access network device, and the first task is a task related to artificial intelligence (AI); and
sending, by the first node, a first message, wherein the first message comprises identification information of a second task or configuration information of the second task, the second task is a subtask of the first task, the second task is executable by a second node, and the second node is configured to execute the first task.

2. The method according to claim 1, wherein the first message further comprises identification information of the first task.

3. The method according to claim 1, wherein a type of the first task comprises any one or more of the following:
an inference task, a training task, a learning task, a computing task, or a sensing task.

4. The method according to claim 1, wherein the determining, by the first node, the first task comprises:
determining, by the first node, any one or more of life cycle information of the first task, resource information of the first task, allocation information of the first task, or decomposition information of the first task.

5. The method according to claim 4, wherein
the life cycle information of the first task comprises any one or more of the following: addition of the first task, modification of the first task, querying of the first task, reporting of the first task, migration of an execution node of the first task, or migration of a management node of the first task;
the resource information of the first task comprises any one or more of the following: computing power of the first task, an algorithm of the first task, data of the first task, or a connection of the first task;
the allocation information of the first task comprises any one or more of the following: allocation of an execution node of the first task, allocation of an execution type of the execution node of the first task, or resource allocation of the execution node of the first task; or
the decomposition information of the first task comprises any one or more of the following: a quantity of tasks obtained by decomposing the first task or computing power decomposition of the first task.

6. The method according to claim 1, wherein the determining, by the first node, the first task comprises:
determining, by the first node, at least two second tasks of the first task, wherein the at least two second tasks correspond to at least two second nodes, which include the second node, and execution types of the at least two second nodes are coordinated execution, or execution types of the at least two second nodes are single-point execution.

7. The method according to claim 1, wherein the method further comprises any one or more of the following:
receiving, by the first node, capability information from the second node, wherein the capability information indicates a capability of the second node to execute a task;
sending, by the first node, a resource configuration request to the second node, wherein the resource configuration request is usable to request to perform resource configuration on the second task;
receiving, by the first node, a second message, wherein the second message indicates an execution result of the second task; or
receiving, by the first node, at least two second messages, and combining execution results of the first task based on the at least two second messages, wherein at least one second message of the at least two second messages indicates an execution result of the second task.

8. The method according to claim 1, wherein
the second node comprises one or more of the following: a second core network device, a second access network device, or a terminal device;
the second access network device comprises one or more of the following: a base station, a central unit (CU), a distributed unit (DU), a central unit-control plane (CU-CP), or a central unit-user plane (CU-UP); and
the second core network device comprises one or more of the following: access and mobility management (AMF), a session management function (SMF), a user plane function (UPF), a network exposure function (NEF), a network repository function (NRF), a policy control function (PCF), unified data management (UDM), an application function (AF), or an authentication server function (AUSF).

9. The method according to claim 8, wherein a protocol layer for interaction between the first core network device and the terminal device is located above a non-access stratum (NAS), or is located in the NAS;
a protocol layer for interaction between the first access network device and the terminal device is located above radio resource control (RRC) layer, or is located in the RRC layer; or
a protocol layer for interaction between the first access network device and the terminal device is located above a service data adaptation protocol (SDAP) layer, or is located in the SDAP layer; or
the terminal device interacts with the DU by using the CU, and a protocol layer for interaction between the terminal device and the CU is located above RRC layer, or a protocol layer for interaction between the terminal device and the CU is located in the RRC layer; or
a protocol layer for interaction between the terminal device and the DU is located in a physical (PHY) layer and a media access control (MAC) layer; or
a protocol layer for interaction between the CU and the DU is located above an F1 interface application protocol (F1AP) layer, is located in the F1AP layer, or is located above representational state transfer (RST) layer; or
a protocol layer for interaction between the CU-CP and the CU-UP is located above an E1 interface application protocol (E1AP) layer, is located in the E1AP layer, or is located above the RST layer; or
a protocol layer for interaction between the first core network device and the first access network device is located above an Ng interface application protocol (NgAP) layer, is located in the NgAP layer, is located above a general packet radio system (GPRS) tunneling protocol-user plane (GTP-U) layer, is located above the GTP-U layer, or is located above the RST layer; or
a protocol layer for interaction between the first access network device and the second access network device is located above an Xn interface application protocol (XnAP) layer, is located in the XnAP layer, or is located above the RST layer; or
a protocol layer for interaction between the first core network device and the second core network device is located above the RST layer.

10. The method according to claim 1, wherein the sending, by the first node, the first message comprises:
sending, by the first node, the first message to the second node, wherein the second node is a node determined by the first node and is configured to execute the first task; and the first node comprises the first core network device, and the second node comprises the second core network device or the terminal device, or the first node comprises the first access network device, and the second node comprises the second access network device and the terminal device; or
sending, by the first node, the first message to the second node by using a forwarding node, wherein the second node is determined by the forwarding node and is configured to execute the first task, the first node comprises the first core network device, the forwarding node comprises the first access network device, and the second node comprises the second access network device or the terminal device.

11. A task processing method, wherein the method comprises:
receiving, by a second node, a first message from a first node, wherein the first message comprises identification information of a second task or or configuration information of the second task, the second task is a subtask of a first task, the first task is a task related to artificial intelligence (AI), and the first node comprises a first core network device or a first access network device; and
executing, by the second node, the second task.

12. The method according to claim 11, wherein the receiving, by the second node, the first message comprises:
receiving, by the second node, the first message from the first node, wherein the second node is configured to execute the first task; and the first node comprises the first core network device, and the second node comprises a second core network device or a terminal device, or the first node comprises the first access network device, and the second node comprises a second access network device and a terminal device; or
receiving, by the second node by using a forwarding node, the first message from the first node, wherein the second node is one of nodes that are determined by the forwarding node and is configured to execute the first task, the first node comprises the first core network device, the forwarding node comprises the first access network device, and the second node comprises a second access network device or a terminal device.

13. The method according to claim 11, wherein the method further comprises any one or more of the following:
sending, by the second node, capability information, wherein the capability information indicates a capability of the second node to execute a task;
receiving, by the second node, a resource configuration request, wherein the resource configuration request is usable to request to perform resource configuration on the second task; or
sending, by the second node, a second message, wherein the second message indicates an execution result of the second task.

14. The method according to claim 11, wherein the second node comprises one or more of the following: the second core network device, the second access network device, or the terminal device;
the second access network device comprises one or more of the following: a base station, a central unit (CU), a distributed unit (DU), a central unit-control plane (CU-CP), or a central unit-user plane (CU-UP); and
the second core network device comprises one or more of the following: access and mobility management (AMF), a session management function (SMF), a user plane function (UPF), a network exposure function (NEF), a network repository function (NRF), a policy control function (PCF), unified data management (UDM), an application function (AF), or an authentication server function (AUSF).

15. The method according to claim 14, wherein a protocol layer for interaction between the first core network device and the terminal device is located above a non-access stratum (NAS), or is located in the NAS; or
a protocol layer for interaction between the first access network device and the terminal device is located above radio resource control (RRC) layer, or is located in the RRC layer; or
a protocol layer for interaction between the first access network device and the terminal device is located above a service data adaptation protocol (SDAP) layer, or is located in the SDAP layer; or
the terminal device interacts with the DU by using the CU, and a protocol layer for interaction between the terminal device and the CU is located above the RRC layer, or a protocol layer for interaction between the terminal device and the CU is located in the RRC layer; or
a protocol layer for interaction between the terminal device and the DU is located in a physical (PHY) layer and a media access control (MAC) layer; or
a protocol layer for interaction between the CU and the DU is located above an F1 interface application protocol (F1AP) layer, is located in the F1AP layer, or is located above representational state transfer (RST) layer; or
a protocol layer for interaction between the CU-CP and the CU-UP is located above an E1 interface application protocol (E1AP) layer, is located in the E1AP layer, or is located above the RST layer; or
a protocol layer for interaction between the first core network device and the first access network device is located above an Ng interface application protocol (NgAP) layer, is located in the NgAP layer, is located above a general packet radio system (GPRS) tunneling protocol-user plane (GTP-U) layer, is located above the GTP-U layer, or is located above the RST layer; or
a protocol layer for interaction between the first access network device and the second access network device is located above an Xn interface application protocol (XnAP) layer, is located in the XnAP layer, or is located above the RST layer; or
a protocol layer for interaction between the first core network device and the second core network device is located above the RST layer.

16. A communication apparatus, wherein the apparatus comprises at least one processor coupled to at least one memory storing computer program, which when executed by the at least one processor, cause the communication apparatus to:
receive a first message from a first node, wherein the first message comprises identification information of a second task or configuration information of the second task, the second task is a subtask of a first task, the first task is a task related to artificial intelligence (AI), and the first node comprises a first core network device or a first access network device; and
execute the second task.

17. The communication apparatus according to claim 16, wherein the receiving the first message comprises:
receiving the first message from the first node, wherein the communication apparatus is configured to execute the first task; and the first node comprises the first core network device, and the communication apparatus comprises a second core network device or a terminal device, or the first node comprises the first access network device, and the communication apparatus comprises a second access network device and a terminal device; or
receiving by using a forwarding node, the first message from the first node, wherein the communication apparatus is determined by the forwarding node and is configured to execute the first task, the first node comprises the first core network device, the forwarding node comprises the first access network device, and the communication apparatus comprises a second access network device or a terminal device.

18. The communication apparatus according to claim 16, wherein when the computer program is executed by the at least one processor, further cause the communication apparatus to:
send, capability information, wherein the capability information indicates a capability of the communication apparatus to execute the second task;
receive a resource configuration request, wherein the resource configuration request is usable to request to perform resource configuration on the second task; or
send, a second message, wherein the second message indicates an execution result of the second task.

19. The communication apparatus according to claim 16, wherein the communication apparatus comprises one of the following: the second core network device, the second access network device, or the terminal device;
the second access network device comprises one or more of the following: a base station, a central unit (CU), a distributed unit (DU), a central unit-control plane (CU-CP), or a central unit-user plane (CU-UP); and
the second core network device comprises one or more of the following: access and mobility management (AMF), a session management function (SMF), a user plane function UPF, a network exposure function (NEF), a network repository function (NRF), a policy control function (PCF), unified data management (UDM), an application function (AF), or an authentication server function (AUSF).

20. The communication apparatus according to claim 19, wherein a protocol layer for interaction between the first core network device and the terminal device is located above a non-access stratum (NAS), or is located in the NAS; or
a protocol layer for interaction between the first access network device and the terminal device is located above a radio resource control (RRC) layer, or is located in the RRC layer; or
a protocol layer for interaction between the first access network device and the terminal device is located above a service data adaptation protocol (SDAP) layer, or is located in the SDAP layer; or
the terminal device interacts with the DU by using the CU, and a protocol layer for interaction between the terminal device and the CU is located above the RRC layer, or a protocol layer for interaction between the terminal device and the CU is located in the RRC layer; or
a protocol layer for interaction between the terminal device and the DU is located in a physical (PHY) layer and a media access control (MAC) layer; or
a protocol layer for interaction between the CU and the DU is located above an F1 interface application protocol (F1AP) layer, is located in the F1AP layer, or is located above a representational state transfer (RST) layer; or
a protocol layer for interaction between the CU-CP and the CU-UP is located above an E1 interface application protocol (E1AP) layer, is located in the E1AP layer, or is located above the RST layer; or
a protocol layer for interaction between the first core network device and the first access network device is located above an Ng interface application protocol (NgAP) layer, is located in the NgAP layer, is located above a general packet radio system (GPRS) tunneling protocol-user plane (GTP-U) layer, is located above the GTP-U layer, or is located above the RST layer; or
a protocol layer for interaction between the first access network device and the second access network device is located above an Xn interface application protocol (XnAP) layer, is located in the XnAP layer, or is located above the RST layer; or
a protocol layer for interaction between the first core network device and the second core network device is located above the RST layer.
